(19) United States
(12) Patent Application Publication
(10) Pub. No.: US 2026/0115672 A1
(43) Pub. Date: Apr. 30, 2026

(54) POLYOLEFIN FILTRATION MEMBRANE AND PREPARATION METHOD THEREFOR

(71) Applicant: HANGZHOU COBETTER FILTRATION EQUIPMENT CO., LTD., Hangzhou (CN)

(72) Inventors: Jiandong JIA, Hangzhou (CN); Zanqing ZHU, Hangzhou (CN)

(21) Appl. No.: 19/433,040

(22) Filed: Dec. 25, 2025

Related U.S. Application Data
(63) Continuation of application No. PCT/CN2024/101308, filed on Jun. 25, 2024.

(30) Foreign Application Priority Data
Jul. 10, 2023 (CN) 202310839929.2

(51) Int. Cl. B01D 71/26; B01D 69/02; B01D 69/08; B01D 69/12

(52) U.S. Cl. CPC B01D 71/26; B01D 69/02; B01D 69/081; B01D 69/1218; B01D 2323/345; B01D 2325/02833; B01D 2325/04; B01D 2325/24; B01D 2325/40

(57) ABSTRACT

Provided are a polyolefin filtration membrane and a preparation method therefor. The polyolefin filtration membrane includes a main body, both sides of the main body are provided with a first outer surface and a second outer surface, a non-directional tortuous pathway is formed in the main body, and a space between the first outer surface and the second outer surface is composed of continuous fibers. A PMI average pore size of the filtration membrane is 2-100 nm, the filtration membrane has an oxygen-to-carbon ratio in the range from 0.01 to 0.10. High-precision interception and removal of metal particles in a fluid to be filtered, micro-colloidal particles related to metal particles in photoresist, can be achieved through the cooperation between the interception effect of the PMI pore size on the metal particles and the adsorption effect of oxygen-containing functional groups of modified polyolefin molecular chains on the metal particles.

### CROSS-REFERENCE TO RELATED APPLICATIONS

This application is a continuation of International Application No. PCT/CN2024/101308, filed on Jun. 25, 2024, which claims priority to Chinese Patent Application No. 202310839929.2, filed on Jul. 10, 2023. All of the aforementioned applications are incorporated herein by reference in their entireties.

### TECHNICAL FIELD

The present disclosure relates to the technical field of membrane materials, and in particular to a polyolefin filtration membrane and a preparation method therefor.

### BACKGROUND

A polymer filtration membrane, as a thin film made from organic polymer materials, primarily plays a role in filtering and separating impurities. According to different polymers, polymer filtration membranes can be divided into a cellulose polymer filtration membrane, a polyamide polymer filtration membrane, a polysulfone polymer filtration membrane, a polyester polymer filtration membrane, a polyolefin polymer filtration membrane and the like, specific examples are a PP (Polypropylene) membrane, a PVDF (Polyvinylidene fluoride) membrane, a PTFE (Polytetrafluoroethylene) membrane, a CA (Cellulose Acetate) membrane, and an UPE (Ultra-high Molecular Weight Polyethylene) membrane.

The filtration or purification of liquid is usually carried out by enabling a fluid to be filtered to pass through a membrane filter, which is usually used in pharmaceutical, chemical and food industries, and the like. The fluid to be filtered is usually chemically active, such as ultra-high purity water, liquid containing peroxide, and liquid containing an organic solvent. Considering the recycling of the organic solvent, how to further remove impurity particles in the organic solvent has become an important consideration standard for the recycling of the organic solvent.

In Chinese invention patent No. CN110860213B, a thin porous membrane sheet is provided, which is prepared by compounding a porous metal-based support sheet and a porous ceramic membrane layer, where the strength of the composite material is improved through the porous metal-based support sheet. This patent reveals in the background that the composite membrane layer of the porous metal and ceramic materials is prone to membrane defects when heated or cooled, thereby causing problems such as cracks and deformation. When the foregoing membrane is used for the filtration of the organic solvent, impurities such as metal particles damaged and dropped on the membrane layer may be introduced while impurities in the solvent are removed by filtration, affecting the cleanliness of the organic solvent. In addition, the organic solvent is usually chemically corrosive. This also poses certain challenges to the corrosion resistance and durability of the filtration membrane.

The organic solvent nanofiltration membrane, due to its good corrosion resistance, is widely used in water purification fields such as pesticides and industrial fields such as ultra-pure water and organic solvent filtration. In invention patent No. CN116194195A, a nanofiltration membrane is provided, which has excellent tolerance to various organic solvents, can stably maintain the characteristics of the nanofiltration membrane even if the nanofiltration membrane is in contact with various types of organic solvents used in industry, and has good adsorption and interception efficiency for solutes, particles and the like in the organic solvent. However, the objects intercepted and filtered in the foregoing patents are usually non-metal particles, such as plastic particles. For metal particles, due to the fact that metal particles have metal bonds and other factors, the filtration efficiency of the foregoing nanofiltration membrane on the metal particles is low.

In addition, for example, in the field of semiconductors, a semiconductor material mainly includes wafer fabrication materials, which mainly include a silicon wafer, a photoresist, wet electronic chemicals, a sputtering target, and the like. In the wafer fabrication process, the wet electronic chemicals are mainly used to clean pollutants such as particles, organic residues, metal ions, and natural oxide layers; and the semiconductor has strict requirements on wet electronic chemicals in terms of the content of trace metal impurities (such as K, Ca, Al, Ti, Mn, Co, Ni, Cu, Mo, and Au), as well as the size and quantity of particles.

Micro-colloidal particle impurities are usually produced in photoresist filtration, which usually refer to small-molecular particles in the photoresist and micro-impurities in production process. The reason for the formation of the micro-colloidal particle impurities may be that some metal particles or metal ions are inevitably introduced in the photoresist production process, and there are small-molecular particles and micro-impurities introduced in the photoresist production process. The photoresist may age to a certain extent during transportation and storage, and the small-molecular particles in the photoresist as well as the micro-impurities in the production process may surround the metal particles or metal ions and aggregate to form local “agglomerate” gels with the metal particles or metal ions as the core.

Therefore, there is an urgent need for a filtration membrane with good filtration efficiency for metal particles.

### SUMMARY

An objective of the present disclosure is to provide a polyolefin filtration membrane and a preparation method therefor.

To achieve the foregoing objective, the present disclosure employs the following technical solutions: a polyolefin filtration membrane includes a main body, where both sides of the main body are provided with a first outer surface and a second outer surface, respectively, a non-directional tortuous pathway is formed in the main body, and a space between the first outer surface and the second outer surface is composed of continuous fibers;
a PMI (Porous Materials Inc) average pore size of the filtration membrane is 2-100 nm; and
the filtration membrane has an oxygen-to-carbon ratio in the range from 0.01 to 0.10.

The PMI average pore size of the polyolefin filtration membrane provided by the present disclosure is 2-100 nm, reflecting an overall membrane pore size of the polyolefin filtration membrane, and showing that the polyolefin filtration membrane provided by the present disclosure is a nano-scale filtration membrane. The polyolefin filtration membrane can intercept and filter impurities of nano-scale particles to a certain extent, for example, metal particles such as K, Ca, Al, Ti, Mn, Co, Ni, Cu, Mo and Au, so that the polyolefin filtration membrane provided by the present disclosure can meet high-precision filtering requirements in the fields of solvent filtration, semiconductors and the like.

According to the present disclosure, oxygen-containing functional groups are introduced into a molecular chain of the polyolefin filtration membrane by means of grafting modification, thereby meeting filtering requirements for metal particles. The grafting modification can be implemented by irradiation, such as γ-ray irradiation, and UV (Ultraviolet) irradiation. Further, the oxygen-to-carbon ratio of the polyolefin filtration membrane is limited to 0.01-0.10. The applicant has found that when the oxygen-to-carbon ratio of the polyolefin filtration membrane is 0.01-0.10, the polyolefin filtration membrane can effectively adsorb metal particles and exhibits high removal efficiency. The possible reason lies in a fact that after modification, the oxygen-containing functional groups may be further grafted onto the molecular chain of the polyolefin, and the grafting of the oxygen-containing functional groups makes corresponding segments of the polyolefin molecular chain have a certain degree of electronegativity, thereby easily obtaining electrons at the sites of the oxygen-containing functional groups to form lone electron pairs. As the metal particles typically possess empty electron orbitals, “coordination bonds” are formed between the metal particles and the oxygen-containing functional groups via the coordination of the empty orbitals with the lone electron pairs, which enable the implementation of further adsorption of the metal particles. Furthermore, studies have revealed that the polyolefin filtration membrane provided by the present disclosure also exhibits excellent adsorption towards micro-colloidal particles, particularly the micro-colloidal particles associated with metals. Ultimately, the adsorption and removal efficiency of the modified filtration membrane for the metal particles and micro-colloidal particles is greatly improved. When the oxygen-to-carbon ratio of the polyolefin filtration membrane is lower than 0.01, the adsorption and removal efficiency of the filtration membrane with a larger PMI average pore size for the metal particles decreases to a certain extent, the reason may be that insufficient grafting of oxygen-containing functional groups on the surface of the filtration membrane (including both the external surface and the internal pore surfaces) fails to effectively improve the electronegativity of the polyolefin molecular chain, and further leads to a relatively weak adsorption effect of the oxygen-containing functional groups on the metal particles.

For another, further increase of the oxygen-to-carbon ratio means the increase of the oxygen-containing functional groups, which endows the filtration membrane with better ability to absorb the metal particles. The grafting of the oxygen-containing functional groups on the polyolefin molecular chain may manifest as their attachment to the pore surfaces, which may subsequently lead to the decrease in the pore size at the grafting site, thereby increasing the time for feed liquid to flow through the polyolefin filtration membrane and ultimately affecting the flow rate performance of the polyolefin filtration membrane. Therefore, the higher the oxygen-to-carbon ratio, the more the quantity of oxygen-containing functional groups grafted onto the polyolefin molecular chain, the greater the influence of the grafted oxygen-containing functional groups on the pore size, and the more significant the reduction in the flow rate performance of the filtration membrane decreases.

In addition, it is inevitable that the increase of the grafting quantity and degree of the oxygen-containing functional groups is often accompanied with the elution problem of the oxygen-containing functional groups. The applicant has found that when the oxygen-to-carbon ratio of the polyolefin filtration membrane is higher than 0.1, a risk of elution of the polyolefin filtration membrane increases.

In conclusion, the polyolefin filtration membrane of the present disclosure has a PMI average pore size of 2-100 nm, and the polyolefin filtration membranes with the PMI average pore size of 2-100 nm is endowed with better adsorption performance for the metal particles by using the oxygen-to-carbon ratio of 0.01-0.1, which reduces an increased probability of elution of the oxygen-containing functional groups caused by an excessively high oxygen-to-carbon ratio and can avoid the problem of large flow rate attenuation caused by the excessively high oxygen-to-carbon ratio. In addition to that, the filtration membrane with the PMI average pore size of 2-100 nm can intercept the metal particles to a certain extent. The present disclosure can achieve high-precision interception and removal of metal particles in a fluid to be filtered, such as an organic solvent, through the cooperation between the interception effect of the PMI pore size on the metal particles and the adsorption effect of oxygen-containing functional groups of modified polyolefin molecular chains on the metal particles. In addition, the polyolefin filtration membrane provided by the present disclosure can remove the micro-colloidal particle impurities in photoresist filtration by adsorbing “aggregate” gel with the metal particles or metal ions as the core.

There are non-directional tortuous pathways in the main body of the polyolefin filtration membrane of the present disclosure, which refer to randomly oriented groove structures and/or discretely distributed pore structures, and the non-directional tortuous pathways are interconnected. The fibers forming a porous structure of the membrane are continuous. It may be understood that “continuous” means that basically all the fibers are integrally connected to each other, such as integrated formation, without using another adhesive and the like. Unless torn by an external force, the networked fibers cannot be separated from each other. That is, the polyolefin filtration membrane provided by the present disclosure is a single-layer membrane structure rather than a composite membrane structure.

A raw material of the filtration membrane provided by the present disclosure is polyolefin, which is composed of carbon and oxygen elements. The oxygen-to-carbon ratio determined by the X-ray photoelectron spectroscopy (XPS) analysis can better characterize the grafting quantity and degree of the oxygen-containing functional groups grafted and modified via radiation, where the oxygen-to-carbon ratio is calculated by separately analyzing carbon and oxygen spectra to determine relative quantitative proportions of element C in the Cls spectrum and element O in the Ols spectrum, and then the relative quantitative proportions of the element C and the element O are calculated to obtain the overall oxygen-to-carbon ratio of the polyolefin filtration membrane.

A model of an instrument for XPS test is Thermo Scientific K-Alpha of the United States, a target is A1 target, a light spot is about 400 μm, a test depth is not more than 10 nm, a pressure in a sample chamber is less than 2.0×10-7 mbar, an operating voltage is 12 kV, and a filament current is 6 mA. Full-spectrum scanning pass energy is 150 eV, and a step size is 1 eV. Narrow-spectrum scanning pass energy is 50 eV, and a step size is 0.1 eV.

The PMI average pore size of the present disclosure is measured by a PMI pore size analyzer.

According to the present disclosure, the oxygen-to-carbon ratio is further preferably 0.01-0.06. When the oxygen-to-carbon ratio of the polyolefin filtration membrane is controlled at 0.01-0.06, the applicant has found that with the increase of the oxygen-to-carbon ration, the flow rate performance of the polyolefin filtration membrane only decreases slightly, even in the polyolefin filtration membrane with the larger PMI pore size, the flow rate performance does not change. However, after the oxygen-to-carbon ratio is higher than 0.06, the degree of decrease of the flow rate performance of the polyolefin filtration membrane tends to gradually increase, while after the oxygen-to-carbon ratio is higher than 0.1, the flow rate performance of the polyolefin filtration membrane decreases to a relatively large extent, which may affect the filtering efficiency.

Further, the XPS analysis spectrum of the filtration membrane includes “C—O” and “C═O”, where the content of “C—O” is 0.6-5%, the content of “C═O” is 0.5-4.5%, and a ratio of the content of “C—O” to the content of “C═O” is 0.5-2.

According to the present disclosure, the modification of the polyolefin filtration membrane by grafting is often accompanied with the grafting and existence of “C—O” and “C═O”, and the foregoing results can be obtained based on an XPS analysis spectrum result and in conjunction with oxygen spectrum and analysis.

The relative contents of “C—O” and “C—O” are associated with the overall oxygen-to-carbon ratio of the filtration membrane. When the relative contents of “C—O” and “C═O” are low, the quantity of groups such as “C—O” and “C═O” grafted on the polyolefin molecular chain is small, which denotes the decrease of the quantity of lone electron pairs formed by the electronegativity of groups such as “C—O” and “C═O” to a certain extent, and the quantity of “coordination bonds” formed by the cooperation of lone electron pairs with the empty electron orbitals of the metal particles also decreases, which ultimately manifest as low adsorption and removal efficiency of the metal particles as well as the micro-colloidal particles associated with the metal particles.

Meanwhile, nor is the higher the relative contents of “C—O” and “C═O”, the better, the more the quantity of the grafted “C—O” and “C═O”, the more the quantity of the “coordination bonds” formed with the metal particles, that is, the adsorption capacity of the modified filtration membrane for the metal particles becomes stronger. However, with the increase of the quantity of the grafted “C—O” and “C═O”, the degree of attachment of “C—O” and “C—O” to the surface of the hole increases, thereby manifesting obvious decrease of the flow rate of the filtration membrane. For another, with the increase of the quantity of the grafted “C—O” and “C═O”, the probability of elution of “C—O” and “C═O” also increases greatly, thereby affecting the cleanliness of a final filtrate, making it difficult to meet the cleanliness requirements in the fields of solvent filtration, semiconductors and the like.

On the premise that the overall oxygen-to-carbon ratio of the filtration membrane is constant, the filtration membrane inevitably contains “C—O” and “C═O”, where oxygen and carbon in “C═O” share two pairs of electrons, which makes the electrons around the oxygen element in an 8-electron stable state, causing the ability of attracting electrons in “C—O” more biased towards carbon; and oxygen and carbon in “C—O” share a pair of electrons, the oxygen can still attract electrons further, and the electronegativity of oxygen is greater than that of carbon, so it is considered that the electronegativity of “C—O” is greater than that of “C═O”. Experimental studies have shown that the higher the content of “C—O”, the better the adsorption performance of the filtration membrane for the metal particles. The electronegativity of “C—O” is relatively higher than that of “C═O”, and it is easier for “C—O” to get electrons and form lone electron pairs. As the metal particles have empty electron orbitals, the lone electron pairs of “C—O” and “C—O” may cooperate with the empty electron orbitals of metal particles to form “coordination bonds” to achieve the adsorption of the metal particles.

Therefore, according to the present disclosure, the contents of the “C—O” group and the “C═O” group are limited to 0.6-5% and 0.5-4.5%, respectively, and the content of “C—O” is higher than that of “C—O”. As the electronegativity of “C—O” is relatively stronger than that of “C═O”, the relative content of the “C—O” is controlled to be higher than that of “C═O”, so that the filtration membrane has good adsorption capacity and removal efficiency for the metal particles in a case that the overall oxygen-to-carbon ratio is 0.01-0.1.

Compared with “C═O”, although “C—O” can endow the modified filtration membrane with good “electronegativity” and metal particle adsorption and removal efficiency, “C═O” is inevitably grafted during modification. When the content of “C—O” is excessively low, the “electronegativity” endowed to the filtration membrane by the “C—O” group may be insufficient, thereby leading to the decrease of the adsorption and removable efficiency of the filtration membrane for the metal particles.

Further, the polyolefin is crystalline polyolefin, and the crystallinity of the filtration membrane measured by the XRD (X-ray diffraction) method is 45-85%.

When the polyolefin is crystalline polyolefin, such as UPE, the crystalline polyolefin is used as a crystalline substance, and a crystallization behavior of the crystalline polyolefin makes the crystalline polyolefin filtration membrane directionally arranged to form a crystalline region and an amorphous region. The crystallinity of the polyolefin filtration membrane provided by the present disclosure is further limited to 45-85%, the higher the crystallinity of the crystalline polyolefin filtration membrane, the more stable the structure of the crystal, and the better the low elution performance of the crystal. The applicant has found that when the crystallinity of the crystalline polyolefin filtration membrane is 45-85%, the crystalline polyolefin filtration membrane is subjected to TOC elution amount test, the elution amount of the TOC can satisfy the cleanliness standard in the fields of solvent filtration, semiconductors and the like.

It is generally considered that the higher the crystallinity of the crystalline polyolefin filtration membrane, the better the low elution performance of the crystalline polyolefin filtration membrane, so that the crystallinity of the crystalline polyolefin filtration membrane can be improved as much as possible. According to the present disclosure, the polyolefin filtration membrane is modified by irradiation grafting modification, for example, the irradiation (γ rays, UV irradiation and the like) way is used for irradiation modification. For example, under γ-ray irradiation, the molecular chain of the crystalline polyolefin undergoes chain scission to form short-chain molecules, which exhibit higher mobility and can further promote crystallization, manifested as a further increase in crystallinity. As such, the further increase in crystallinity leads to a rise in the oxygen-to-carbon ratio. The increase in the oxygen-to-carbon ratio may enhance the degree of attachment on the pore surface, which in turn leads to the decrease in the overall flow rate of the filtration membrane. This may make the filtration membrane difficult to apply in a high-flow-rate filtration application. Therefore, an upper limit of the crystallinity in the present disclosure is 85%, and it is not the case that the higher the crystallinity, the better.

In addition, the applicant has found that when the crystallinity is 45-85%, the higher the crystallinity of the crystalline polyolefin filtration membrane, the better the low elution performance of the crystalline polyolefin filtration membrane, and the stronger the strength of the crystalline polyolefin filtration membrane. The possible reason is that the higher the crystallinity of the crystalline polyolefin filtration membrane, the better the own low elution performance of the crystalline polyolefin filtration membrane, and the better the heat resistance of the crystalline polyolefin filtration membrane, thereby further reducing a probability that the grafted oxygen-containing functional groups fall off or dissolve out after being heated, which is beneficial to improving the overall low elution performance of the crystalline polyolefin filtration membrane.

The crystallinity obtained by the XRD method in the present disclosure means that original image data obtained by X-ray diffraction is subjected to peak fitting by Jade software to obtain the fitted peaks of the crystalline region and the amorphous region, in which the fitted peaks of the crystalline region are around 2θ=19.6°, 2θ=21.6° and 2θ=23.7°, and the remaining fitted peaks are fitted peaks representing the amorphous region, and then the fitted peak area of each of the crystalline region and the amorphous region is calculated by integration. The crystallinity provided by the present disclosure is equal to an integrated fitted peak area of the crystalline region divided by the sum of the integrated fitted peak area of the crystalline region and the integrated fitted peak area of the amorphous region. A model of an instrument for XRD test is Rigaku Ultima IV in Japan, with a step size of 0.02, a tube voltage of 40 kV and a tube current of 40 m.

The crystallinity of the crystalline polyolefin filtration membrane provided by the present disclosure is further preferably 55-70%. When the crystallinity of the crystalline polyolefin filtration membrane is 55-70%, it is found that the degree of attenuation of the flow rate performance of the filtration membrane is low for the increase of crystallinity. When the crystallinity of the polyolefin filtration membrane provided by the present disclosure is further increased, the flow rate performance of the filtration membrane is attenuated to a certain extent, and a more significant attenuation in the flow rate performance of the filtration membrane occurs when the crystallinity exceeds 85%.

Further, the filtration membrane satisfies that a ratio of I_{orthogonal crystal form} to I_{monoclinic phase} is greater than or equal to 50;

I_{orthogonal crystal form} is a scattering intensity of an UPE filtration membrane at 2θ angles around 21.6° and 23.7°; and

I_{monoclinic phase} is a scattering intensity of the UPE filtration membrane at a 2θ angle around 19.6°.

When the polyolefin of the present disclosure is the UPE, the monoclinic phase and the orthorhombic crystal form are common crystal types of UPE, where the orthorhombic crystal form, as the most common crystal form, has good thermal stability, can endow the filtration membrane with good thermal stability and improve the grafting stability of irradiation-grafted groups to a certain extent, which in turn helps reduce a probability of elution of the irradiation-grafted groups. Compared with the orthogonal crystal form, the monoclinic phase has a larger included angle between adjacent crystal faces and has a surface tension greater than that of the orthogonal crystal form, and a proper proportion of monoclinic phase can improve the surface tension of filtration membrane. However, due to its thermal stability is poor, the monoclinic phase may be transformed into the orthogonal crystal form when subjected to thermal effect. The higher the proportion of the orthogonal crystal form, the relatively better the heat resistance stability of the filtration membrane, and the relatively better the grafting stability of the irradiation-grafted groups, thereby reducing the probability of elution of the irradiation-grafted groups. In addition, the better the grafting stability of the irradiation-grafted groups, the better the sustained adsorption capacity of the irradiation-grafted groups for the metal particles, thereby improving the interception efficiency for the metal particles.

Further, a full width at half maximum of a characteristic peak of the filtration membrane at the 2θ angle around 21.6° is 0.4°-1.5°; and a full width at half maximum of a characteristic peak of the filtration membrane at the 20 angle around 23.7° is 0.4°-1.5°.

In general, the narrower the full width at half maximum of the crystalline characteristic peak, the smaller the crystallinity of the crystal; and the greater the crystal grain, and the relatively perfect of the structure of the crystal. If the full width at half maximum of the crystalline characteristic peak is excessively wide, it is indicated that the characteristics of the crystalline region are not obvious. The UPE filtration membrane provided by the present disclosure has a relatively suitable full width at half maximum at an absorption characteristic peak of the orthogonal crystal form, which reflects that the UPE filtration membrane of the present disclosure has a relatively complete crystalline region of the orthogonal crystal form and good crystallinity, and the crystalline region has a relatively large crystal grain and a relatively perfect crystal structure, thereby endowing the filtration membrane with relatively good low elution performance.

Further, an SEM (Scanning Electron Microscopy) average pore size of the first outer surface is not less than that of the second outer surface, the SEM average pore size of the second outer surface is 15-100 nm, and a thickness of the filtration membrane is 20-120 μm.

Generally, the second outer surface of the filtration membrane of the present disclosure can serve as a liquid outlet surface, and the oxygen-to-carbon ratio of the second outer surface is more concerned, this is because the feed liquid is called a filtrate after it flows through the second outer surface. In this case, if elution occurs near the second outer surface or the adsorption capacity for the metal particles is insufficient, the cleanliness of the filtrate will be greatly affected. However, even if the elution occurs at the first outer surface or the adsorption capacity for the metal particles is insufficient, the filtration membrane, due to the owning of a certain thickness, can still further adsorb the eluted molecules or metal particles from the feed liquid in the thickness direction. The impact of either elution occurring on the first outer surface or insufficient adsorption for the metal particles on the cleanliness of the filtrate is relatively small.

The vicinity of the second outer surface plays a major adsorption role in the filtration process. The SEM average pore size of the second outer surface is 15-100 nm, and the PMI average pore size of the filtration membrane is 2-100 nm. The small pore size of the second outer surface reflects a large specific surface area of the pores on the second outer surface to some extent, and with the oxygen-to-carbon ratio distribution near the second outer surface, the pores on the second outer surface are endowed with better adsorption capacity for metal particles. In addition to that, the PMI pore size of the filtration membrane enables effective interception to the nano-scale particles, so that the metal particles in the feed liquid can be intercepted and removed to a certain extent.

After characterizing a morphology of a membrane structure by using a scanning electron microscope, the SEM average pore size of the first outer surface of the membrane, the SEM average pore size of the second outer surface, an average diameter of the cross-sectional fibers and the diameter of the surface fibers of the first and second outer surfaces can be measured with computer software (such as Matlab, NIS-Elements) or manually, followed by calculation correspondingly. In the preparation process of the membrane, the features of the membrane, such as pore size distribution, are generally uniform and basically consistent in a direction perpendicular to the thickness of the membrane. Therefore, the overall average pore size on a plane can be reflected by the average pore size of some regions on a corresponding plane. During actual measurement, the membrane surface is characterized with the scanning electron microscope to obtain a corresponding SEM diagram. As the pores on the membrane surface are approximately uniform, a certain area can be selected, for example, 1 μm² (1 μm multiplied by 1 μm) or 25 μm² (5 μm multiplied by 5 μm), the specific area depends on the actual situation, and then the pore sizes of all pores on this area are measured by corresponding computer software or manually, and then the average pore size of the pores on this surface is obtained by calculation. Certainly, those skilled in the art may also obtain the foregoing parameters by other measurement means, and the foregoing measurement means are for reference only.

Further, a pore area ratio of the second outer surface is 10-30%, and a pore density of the second outer surface is 120-300 per μm².

The pore area ratio of the second outer surface of the present disclosure is controlled at 10-30%, and the pore density of the second outer surface is controlled at 120-300 per μm², so that the distribution of solid parts of the second outer surface is relatively uniform, and the second outer surface is endowed with a more stable flow rate and an adsorption effect for the metal particles. If the pore area ratio and pore density of the second outer surface are too high, this indicates that the proportion of the solid part on the second outer surface is relatively small, which in turn may result in lower strength of the pores on the second outer surface. Conversely, if the pore area ratio and pore density of the second outer surface are too low, this indicates that the proportion of the solid part on the second outer surface is relatively large, which in turn may lead to lower flow rate performance of the second outer surface.

The crystallinity of the filtration membrane of the present disclosure is limited in the range of 45-85%, making the own low elution performance of the solid part on the second outer surface better. In addition to that, the solid part has higher crystallinity and also has excellent impact resistance, strength and thermal stability, which in turn reduces the probability that the irradiation-grafted groups are eluted after being impacted by the feed liquid and heated, making the filtrate have higher cleanliness.

After characterizing a morphology of a membrane structure by using a scanning electron microscope, the pore area ratio and pore density of each of the first outer surface and the second outer surface in the present disclosure can be measured with computer software (such as Matlab, NIS-Elements) or manually, followed by calculation correspondingly. In the preparation process of the membrane, the features of the membrane, such as pore size distribution, are generally uniform and basically consistent in a direction perpendicular to the thickness of the membrane. Therefore, the overall pore area ratio and pore density on a plane can be reflected by the pore area ratio and pore density of some regions on a corresponding plane. During actual measurement, the membrane surface is characterized with the scanning electron microscope to obtain a corresponding SEM diagram. As the pores on the membrane surface are approximately uniform, a certain area can be selected, for example, 1 μm² (1 μm multiplied by 1 μm) or 25 μm² (5 μm multiplied by 5 μm), the specific area depends on the actual situation, and then the area of all pores and the quantity of all pores on this area are measured by corresponding computer software or manually, and then the pore area ratio and pore density of each of the first outer surface and the second outer surface is obtained by calculation. Certainly, those skilled in the art may also obtain the foregoing parameters by other measurement means, and the foregoing measurement means are for reference only.

Further, an overall porosity of the filtration membrane is 20-70%, the filtration membrane is provided with second cross-sectional fibers close to the second outer surface in a thickness direction, and an SEM average diameter of the second cross-sectional fiber is 30-100 nm.

When the overall porosity of the filtration membrane remains constant, the thinner the diameter of the cross-sectional fiber, the greater the specific surface area of the cross-sectional fiber, and the stronger the adsorption capacity of the cross-sectional fiber. When the porosity of the filtration membrane is kept at 20-70% and the second cross-sectional fiber is controlled at 30-100 nm, the second cross-sectional fiber has strong adsorption capacity, which can further adsorb molecules eluted near the first outer surface, thereby reducing the influence of elution near the first outer surface on the purity of filtrate. In addition to that, the better the adsorption capacity of the second cross-sectional fiber, the higher the adsorption removal rate of the metal particles in the feed liquid.

Meanwhile, generally speaking, the thinner the diameter of the cross-sectional fiber, the worse its strength, which may also lead to the easier elution of the cross-sectional fiber. However, the filtration membrane of the present disclosure has higher crystallinity, which in turn enhances the strength of the second cross-sectional fiber, and the problems of insufficient strength and elution caused by the thinner diameter of the second cross-sectional fiber is avoided as much as possible.

The porosity of the membrane refers to a ratio of membrane pore volume of the filtration membrane to the total volume, and membrane pores include open pores and closed pores. Commonly used porosity testing methods include a mercury intrusion method, a density method and a wet and dry membrane weighing method. Certainly, those skilled in the art may also obtain the foregoing parameters by other measurement means, and the foregoing measurement means are for reference only.

Further, filtration membrane has a weight-average molecular weight from 2 million to 5 million, and a first water contact angle of the second outer surface is 40°-120°.

Generally speaking, a substance with a larger weight-average molecular weight have better low elution performance in comparison with a substance with a smaller weight-average molecular weight. Based on the porosity of the filtration membrane and the diameter of the second cross-sectional fiber, the larger weight-average molecular weight is employed in the present disclosure to maintain the low elution performance of the second cross-sectional fiber at a better level under the action of the larger weight-average molecular weight and high crystallinity even if the diameter of the second cross-sectional fiber is thinner, so that the second cross-section fiber may have excellent low elution performance while adsorbing eluted molecules and the metal particles in the feed liquid, and the cleanliness of the filtrate is in turn improved.

As the polyolefin molecular chains are entirely composed of hydrophobic groups and the XPS test reveals that the oxygen-containing functional groups are grafted onto the polyolefin molecular chains after irradiation modification, the degree of grading of the oxygen-containing functional groups after irradiation modification can be characterized to a certain extent by comparing a first water contact angle of the polyolefin filtration membrane before and after irradiation modification. A water contact angle of the second outer surface is 40°-120°, which reflects the quantity of the grafted oxygen-containing functional groups onto the second outer surface to some extent, thereby ensuring the adsorption effect on the metal particles. In addition, combined with the weight-average molecular weight and crystallinity of the filtration membrane, the filtration membrane reduces the influence of the elution on the cleanliness of the filtration while ensuring the filtration efficiency of the metal particles.

The weight-average molecular weight can be obtained as follows: a sample of the polyolefin filtration membrane is heated and dissolved in o-dichlorobenzene, and determined by GPC (Gel Permeation Chromatograph) liquid chromatograph under the conditions of a column temperature of 135° C. and a flow rate of 1.0 mL/min.

The first water contact angle refers to a regular contact angle formed within 0.4 seconds immediately after a 10-100 μL water droplet is evenly deposited on the material surface, where water is as test liquid and measured by a contact angle meter.

Further, the filtration membrane is provided with first cross-sectional fibers close to the first outer surface along the thickness direction, an SEM average diameter of the first cross-sectional fiber is 30-110 nm, and a first water contact angle of the first outer surface is 40°-120°.

Generally, the first outer surface can serve as a liquid inlet surface, the first water contact angle of the first outer surface is 40°-120°, which reflects the degree of grafting of the oxygen-containing functional groups on the first outer surface, so that the first outer surface is endowed with excellent adsorption capacity for the metal particles. For another, the diameter of the first cross-section fiber is 30-100 nm, which has a large specific surface area and better adsorption capacity, and thus can adsorb the eluted molecules and the metal particles in the feed liquid to a certain extent. Under the action of the large weight-average molecular weight and high crystallinity, the low elution performance of the first cross-section fiber can be maintained at an excellent level, which in turn reduces the influence on the cleanliness of the filtrate.

When the diameter of the first cross-sectional fiber is too large, the specific surface area of the first cross-sectional fiber is relatively small, and the adsorption capacity is poor, which is not conducive to the adsorption of metal particles and like impurities in the feed liquid. When the diameter of the first cross-sectional fiber is too small, the strength of the first cross-sectional fiber is poor, leading to easier elution of the cross-sectional fibers.

Further, the SEM average pore size of the first outer surface is greater than that of the second outer surface, and the SEM average pore sizes from the first outer surface to the second outer surface gradually change in a gradient manner, the SEM average pore size of the first outer surface is 500-2000 nm, and the SEM average pore size of the second outer surface is 15-100 nm.

When the filtration membrane of the present disclosure is an asymmetrical membrane, as the pore size near the first outer surface is relatively large, the pre-filtration for the feed liquid can be achieved, the dirt-holding capacity of the filtration membrane is improved, and a relatively fast flow rate of the feed liquid when flowing through the filtration membrane is ensured. The feed liquid has a great impact on the pores near the first outer surface, and the increase of the quantity of irradiation-grafted oxygen-containing functional groups is easy to cause the elution of .the irradiation-grafted groups. As the pore size near the second outer surface is small, impurities such as metal particles in the feed liquid can be intercepted to a certain extent. There are relatively more irradiation-grafted oxygen-containing functional groups near the second outer surface, which endows the vicinity of the second outer surface with excellent adsorption capacity for metal particles, and can ensure full adsorption of the metal particles. In addition, even if elution occurs near the first outer surface, the vicinity of the second outer surface can adsorb eluted molecules to a certain extent. Through the radiation-grafted groups on the first and second outer surfaces, as well as the asymmetric pore sizes, the filtration membrane can ensure the adsorption efficiency for the metal particles in the feed liquid under the condition of an oxygen-to-carbon ratio of 0.01-0.1, and has a relatively small impact on the flow rate, making it suitable for application in filtration fields that require high flow rates and high dirt-holding capacities.

Further, a pore density of the first outer surface is 0.5-80 per μm², and a pore area ratio of the first outer surface is 10-25%.

The pore density and pore area ratio of the first outer surface are controlled within 0.5-80 per μm² and 10-25%, respectively. As the pore area ratio of the first outer surface is calculated from the pores and the quantity of these pores, on one hand, it is reflected that the pore size of the pore on the first outer surface is relatively large, and on the other hand, it is reflected that the distribution of the pores on the first outer surface is relatively uniform, thereby enabling the feed liquid to achieve a better flow rate when flowing through the first outer surface. In addition, as the filtration membrane has a certain porosity and higher crystallinity (which reflects the proportion of the solid part in the filtration membrane to a certain extent), the solid part of the first outer surface has good pressure and impact resistance, which can reduce the elution probability of the irradiation-grafted groups to a certain extent. Moreover, the higher crystallinity also endows the first outer surface with excellent low elution performance.

Further, the SEM average pore sizes from the first outer surface to the second outer surface are arranged symmetrically, and the SEM average pore sizes of the first outer surface and the second outer surface are 15-100 nm.

When the filtration membrane of the present disclosure is a symmetrical membrane, the pore size distribution of the whole membrane is relatively uniform. The symmetrical membrane has a good interception effect on impurities such as metal particles in the feed liquid. Due to relatively uniformly pore size distribution of the symmetrical membrane, the grafting uniformity of the irradiated oxygen-containing functional groups is relatively better, so that the filtration membrane has a better adsorption performance for the metal particles, and to a certain extent, the stability of the irradiation-grafted oxygen-containing functional groups is better, which in turns ensures the sustained adsorption for the metal particles in the feed liquid while reducing the elution probability of the irradiation-grafted groups. The cleanliness of the final filtrate is improved, and the filtration membrane is suitable for application in filtration fields that require high flow rates and high dirt-holding capacities.

Further, the pore density of the first outer surface is 150-300 per μm², and the pore area ratio of the first outer surface is 10-30%.

When the filtration membrane of the present disclosure is a symmetrical membrane, the pore size of the first outer surface is relatively small, which mainly plays a role in removing the particles. The higher the pore density of the first outer surface, the more the quantity of the oxygen-containing functional groups grafted to the pores of the first outer surface, thereby endowing the pores near the first outer surface with excellent adsorption capacity for the metal particles. In addition, the setting of the larger pore density and pore area ratio reflects that the pore size on the first outer surface is relatively small and uniformly distributed, and with the setting of higher crystallinity, the pores near the first outer surface have better low elution performance and compressive strength, so that the filtration membrane can continuously adsorb metal particles from the feed liquid.

Further, an average diameter of the fibers on the first outer surface is 50-150 nm, and an average diameter of the fibers on the second outer surface is 50-100 nm.

Comparing the fibers on the first outer surface with those on the second outer surface in the present disclosure, the first outer surface, as a liquid inlet surface, is continuously impacted by the feed liquid, so that the first outer surface is more prone to elution than the second outer surface. The average diameter of the fibers on the first outer surface is 50-150 nm, so that the fibers on the first outer surface have excellent strength and self-elution performance. In addition, the feed liquid is called filtrate after flowing through the second outer surface, so the diameter of the fiber on the second outer surface is controlled at 50-100 nm. With the setting of the high crystallinity, the fibers on the second outer surface have excellent low elution performance, thereby reducing the influence on the cleanliness of the filtrate.

Further, the filtration membrane has a longitudinal tensile strength of 6-18 MPa, and a transverse tensile strength of 4-16 MPa; an evolution amount of TOC (Total Organic Carbon) from the filtration membrane does not exceed 0.5 ppb; and under a positive pressure of 0.03 MPa and a temperature of 20° C., time required for 50 ml of water to pass through a porous filtration membrane with a diameter of 47 mm is 100-3000 s.

The longitudinal tensile strength and transverse tensile strength in the present disclosure have good numerical values, thereby endowing the filtration membrane better impact resistance and reducing the probability of elution of the filtration membrane to a certain extent. In addition, through the TOC elution amount test, it can be found that the filtration membrane provided by the present disclosure has a low elution amount, so that the filtration membrane can be applied to the filtration fields of solvent filtration, semiconductors, ultra-pure water and the like. Afterwards, the filtration membrane of the present disclosure has little influence on the flow rate of the filtration membrane after irradiation modification.

Further, the polyolefin is any one of PE (Polyethylene), PP (Polyethylene) and UPE.

Further, the present disclosure discloses a preparation process for a polyolefin filtration membrane, which includes the following process steps:

S1, preparing a modification solution, where sulfite with a mass fraction of 2.5-10% and a surfactant with a mass fraction of 1-5% are added into water to prepare the modification solution;

S2, immersing a filtration membrane in an alcohol solution, placing the infiltrated filtration membrane into pure water for immersing and rinsing, and immersing the filtration membrane in the modification solution for feed-liquid replacement; and

S3, irradiating the filtration membrane immersed with the modification solution by rays, controlling ray irradiation to control an oxygen-to-carbon ratio of the filtration membrane within 0.01-0.1, removing the filtration membrane from the modification solution, immersing the filtration membrane in the pure water, and drying the filtration membrane to obtain a polyolefin filtration membrane.

The polyolefin filtration membrane provided by the present disclosure is grafted with oxygen-containing functional groups by irradiation modification, and the polyolefin filtration membrane can be subjected to grafting modification by γ-ray irradiation and UV irradiation in the present disclosure, and the oxygen-to-carbon ratio of the polyolefin filtration membrane is controlled within 0.01-0.1, thereby endowing the polyolefin filtration membrane with adsorption performance for metal particles and related gels.

An objective of immersing the filtration membrane in an alcohol solvent is that all hydrophobic groups in an original polyolefin filtration membrane make the original polyolefin filtration membrane hydrophobic, a way that the original polyolefin filtration membrane is in direct contact with the modification solution and modified may lead to a situation that the modification solution cannot infiltrate the original polyolefin filtration membrane well, but the modification solution can infiltrate and wet the original polyolefin filtration membrane through the wetting of an alcohol solvent better. Then, after the membrane is infiltrated with the alcohol solvent, an objective of rinsing with the pure water is to remove the influence of the alcohol solvent in the irradiation modification process.

Further, in step S3, the filtration membrane immersed with the modification solution is subject to UV irradiation, a temperature of feed liquid is controlled at 30-50° C., an irradiance is controlled at 10-200 mW/cm², a wavelength of the UV irradiation is 100-320 nm, and the irradiation lasts for 10-30 min.

According to the present disclosure, the polyolefin filtration membrane is subjected to grafting modification with UV irradiation, and compared with UV light with a long wavelength, the UV light with short and medium wavelengths contains higher energy for initiating reactions, thereby achieving a better grafting modification effect on the polyolefin filtration membrane and endowing the polyolefin filtration membrane with better adsorption capacity for metal particles and metal-related micro-colloid particles.

Further, in step S3, the filtration membrane is immersed in a container filled with the modification solution, and the container is sealed and then vacuumized for 1-3 h; the container filled with the modification solution and the filtration membrane is subjected to γ-ray irradiation with an irradiation intensity of 2-4 Mrad/h for 13-25 h, the temperature of the feed liquid is controlled at 30-50° C., and a total radiation dose is 25-50 Mrad; and the filtration membrane is immersed in the pure water after being removed from the solution, and then dried to obtain the polyolefin filtration membrane.

According to the present disclosure, the polyolefin filtration membrane is subjected to grafting modification by using γ-rays. Through relatively high feed liquid temperature and relatively high total irradiation dose, the grafting reaction of the polyolefin filtration membrane is more intense, so that the degree of grafting of the oxygen-containing functional groups on the polyolefin filtration membrane is better, and the polyolefin filtration membrane is endowed with better adsorption capacity for the metal particles.

Further, the filtration membrane is further subjected to pretreatment, the pretreatment includes γ-ray pretreatment:
(1) preparing a pre-modification solution, where sulfite with a mass fraction of 1-5% and a surfactant with a mass fraction of 0.5-2.5% are added into water to prepare the pre-modification solution, and the mass fractions of the sulfite and a surfactant in the pre-modification solution are lower than those of the sulfite and the surfactant in the modification solution;
(2) immersing the filtration membrane in an alcohol solution, placing the infiltrated filtration membrane in the pure water for immersing and rinsing, and immersing the filtration membrane in a container filled with the pre-modification solution for feed-liquid replacement, and introducing an oxygen environment; and
(3) irradiating the container filled with the pre-modification solution and the filtration membrane by γ-rays with an irradiation intensity of 0.2-0.5 Mrad/h for 16-40 h, wherein irradiation time in the pre-modification process is longer than that in the modification process, the temperature of the feed liquid is controlled at 10-25° C., and the total radiation dose is 4-8 Mrad; and removing the filtration membrane from the pre-modification solution, and immersing the filtration membrane in the pure water; or
the pretreatment includes UV pretreatment:
(1) preparing a pre-modification solution, wherein sulfite with a mass fraction of 1-5% and a surfactant with a mass fraction of 0.5-2.5% are added into water to prepare the pre-modification solution, and the mass fractions of the sulfite and a surfactant in the pre-modification solution are lower than those of the sulfite and the surfactant in the modification solution;
(2) immersing the filtration membrane in an alcohol solution, placing the infiltrated filtration membrane in the pure water for immersing and rinsing, and immersing the filtration membrane in a container filled with the pre-modification solution for feed-liquid replacement; and
(3) irradiating the container filled with the pre-modification solution and the filtration membrane by UV irradiation, controlling a temperature of the feed liquid at 10-25° C., and controlling an irradiance at 1000-2000 mW/cm², where a wavelength of the UV irradiation is 100-320 nm, and the irradiation lasts for 1-3 h; and removing the filtration membrane from the pre-modification solution, and then immersing the filtration membrane in the pure water.

According to the present disclosure, the polyolefin filtration membrane is subjected to irradiation modification twice, where the first irradiation modification is pre-modification, a pre-modification process may employ either γ-ray radiation or UV radiation. When γ-ray radiation is employed, a low pre-modification solution concentration, a low radiation dose (4-8 Mrad), a low temperature (10-25° C.) and the introduced oxygen environment are employed, a main objective of the first irradiation modification is to pre-graft the polyolefin filtration membrane while increasing the crystallinity of the polyolefin filtration membrane. When the γ-ray is at a low radiation dose (4-8 Mrad), molecular chains of the polyolefin filtration membrane undergo chain scission under the irradiation of the γ-ray, and the molecular chains in chain scission have better activity and can be rearranged and further recrystallized, which in turn makes the crystallinity of the polyolefin filtration membrane increased significantly in a first irradiation modification stage, and further enhances the low elution performance of the polyolefin filtration membrane itself. However, the crosslinking effect in the molecular chains is not obvious at the low radiation dose (4-8 Mrad), and a three-dimensional network structure formed by crosslinking is not conducive to the improvement of the crystallinity. In addition, in the oxygen environment, the molecular chains of the polyolefin filtration membrane undergo chain scission by oxidation at the low radiation dose (4-8 Mrad), the chain scission caused by oxidation reduces the crystallite size and produces a fine crystal phase in the amorphous region, thereby being manifested as the increase of the crystallinity. In addition, compared with the high-concentration modification solution, the low pre-modification solution concentration can better enter the polyolefin filtration membrane for feed-liquid replacement. The low temperature modification environment and low pre-modification solution concentration enable the pre-grafting modification of the polyolefin filtration membrane and make the polyolefin filtration membrane hydrophilic.

In the second irradiation modification, a high modification solution concentration, a high radiation dose (25-50 Mrad), a high temperature (30-50° C.) and a vacuum environment are employed, the second irradiation modification is mainly to further improve the degree of irradiation modification of the polyolefin filtration membrane. The high modified solution concentration and the vacuum environment enable the modification solution to enter the polyolefin filtration membrane under the vacuum effect. In addition, as the solution for the first irradiation modification has certain hydrophilicity, there is no need to use an alcohol solution for wetting during the second irradiation modification, and the high-concentration modification solution can also enter the polyolefin filtration membrane for feed-liquid replacement. A relatively high-temperature environment makes the activity of polyolefin molecular chains more intense, and with the high-concentration modification solution, the polyolefin filtration membrane is more prone to grafting modification, and then the degree of irradiation modification is improved. Twice irradiation modifications can improve the uniform degree of grafting of the irradiation-grafted groups to a certain extent. The applicant has found that when the γ-ray is at the high radiation dose (25-50 Mrad), with the increase of the dose, the crystallinity of the polyolefin filtration membrane after the second irradiation modification rises to a certain extent in comparison with the polyolefin filtration membrane after the first irradiation modification, the possible reason is that under the high radiation dose (25-50 Mrad), a crystalline region begins to melt, and the polymer molecular chains simultaneously undergo complicated processes such as cracking and restructuring. There are still a certain number of short-chain free radicals in the polyolefin filtration membrane, which have strong activity and rearrangement ability. In this case, the action of crystal rearrangement and other behaviors is greater than the cross-linking effect of the molecular chains, which is manifested as the increase of the crystallinity and further improves the low elution performance of the polyolefin filtration membrane.

According to the present disclosure, the irradiation modification is carried out in two steps, the first irradiation modification employs a lower irradiation intensity and longer irradiation time, while the second irradiation modification employs a higher irradiation intensity and a shorter irradiation time. Firstly, those skilled in the art have found that in the process of carrying out irradiation modification on the polyolefin filtration membrane by using the γ-ray, as the process is carried out in a sealed container and a γ-ray irradiation environment is also relatively enclosed, how to maintain a constant temperature of the feed liquid has become a challenge. The temperature of the feed liquid may affect the intensity of the grafting reaction. The applicant has found that in the process of γ-ray irradiation, heat loss occurred in the system with the progress of the grafting reaction. When the low irradiation intensity is used for long-term irradiation in the first irradiation modification, the applicant has found that the temperature of the feed liquid is relatively constant and fluctuates only in a small range, and the possible reason is that γ-ray irradiation may cause heat generation in the system, and the heat generated by the γ-ray with low irradiation intensity (4-8 Mrad) is equivalent to the heat lost in the system, so that the problem of maintaining a constant temperature of the feed liquid is unexpectedly solved. In addition, the cooperation between the low irradiation intensity and long irradiation time in the first irradiation modification process enables the polyolefin filtration membrane to have more time for crystallization and upgrading. In addition, the low-concentration modification solution also makes the interior of the polyolefin filtration membrane have more time for pre-grafting modification.

The higher irradiation intensity is employed in the second irradiation modification, meaning that the γ-ray has higher energy. When the γ-ray with high irradiation intensity is used to irradiate the polyolefin filtration membrane, the increased heat in the system increases, and when the temperature of the feed liquid is controlled at 30-50° C., a heat exchange rate between the feed liquid and the enclosed system also changes, which may be due to a dynamic balance between the heat generated by the γ-ray with high irradiation intensity and the heat lost by the feed liquid system. Therefore, the temperature of the feed liquid is in a relatively constant state under the irradiation intensity of 25-50 Mrad. For another, due to high intensity of the second irradiation modification, the reaction degree between the high-concentration modification solution and the polyolefin filtration membrane is also more intense and the reaction speed is faster, and the irradiation modification process of the polyolefin filtration membrane is easier to reach an expected level, so the irradiation time is controlled to be relatively short. Further increase in the irradiation time cannot further increase the degree of irradiation modification of the polyolefin filtration membrane (there are few effective components left in the modification solution due to the intense and fast reaction). In addition, the further irradiation of the γ-ray may lead to the fracture of grafted molecular chains, which may affect the quantity of the irradiation-grafted groups. Therefore, the time of the second irradiation modification should not be too long.

Secondly, the applicant has found that when the radiation intensity is 0.2-0.5 Mrad/h, the contents of “C—O” and “C—O” are lower than those when the radiation intensity is 2-4 Mrad/h. Additionally, the ratio of “C—O” content to “C═O” content at a radiation intensity of 0.2-0.5 Mrad/h is lower than that at 2-4 Mrad/h. In other words, as the radiation intensity increases, a rate of increase in “C—O” bond is greater than that of “C═O” bond. The possible reason is that at the low irradiation intensity of 0.2-0.5 Mrad/h, the energy generated by γ-ray irradiation for modification grafting is relatively less. In this case, as the bond energy of “C—O” is lower than that of “C═O”, the content of “C—O” is higher than that of “C—O” and a ratio of the content of “C—O” to the content of “C═O” is not high. However, at the irradiation intensity of 2-4 Mrad/h, the energy generated by γ-ray irradiation for modification grafting is relatively abundant. As the bond energy of the “C—O” bond is relatively low, more of this abundant energy is used for the formation of the “C—O” bond, which is further reflected in an increase in the ratio of the content of “C—O” to the content of “C═O”.

In addition, the applicant has found that the effect of γ-ray irradiation may also be achieved by UV irradiation in the pre-modification process. When the irradiance is controlled at 1000-2000 mW/cm², the wavelength of UV irradiation is 100-320 nm, and the irradiation lasts for 1-3 h, the molecular chains of the polyolefin filtration membrane can be pre-grafted and modified to a certain extent, and the crystallinity of the polyolefin filtration membrane can be improved to some extent.

Further, the sulfite is sodium sulfite and potassium sulfite, and the surfactant is sodium dodecyl sulfate and sodium dodecyl benzene sulfonate.

In conclusion, the present disclosure includes at least one of the following beneficial technical effects.

1. The polyolefin filtration membrane of the present disclosure has a PMI average pore size of 2-100 nm and an oxygen-to-carbon ratio of 0.01-0.1. in the present disclosure, the adsorption and removal of the metal particles in an organic solvent can be achieved through the cooperation between the interception effect of the PMI average pore size on the metal particles and the adsorption effect of the oxygen-containing functional groups on the polyolefin molecular chain after irradiation modification on the metal particles, and the micro-colloidal particle impurities in photoresist filtration may also be removed by adsorbing “aggregate” gel with the metal particles or metal ions as the core. In addition, the increase in an elution probability of the oxygen-containing functional groups due to too high oxygen-to-carbon ratio is reduced, and the influence of irradiation modification grafting on the flow rate of the filtration membrane is also reduced.

2. The filtration membrane of the present disclosure has a crystallinity of 44-85%, the polyolefin filtration membrane is endowed with better low elution performance, and the influence of the elution of more groups modified and grafted via irradiation on the cleanliness of filtrate is further reduced. In addition, the polyolefin filtration membrane is endowed with better heat resistance, thereby reducing the probability that the grafted oxygen-containing functional groups fall off or dissolve out after being heated, which is beneficial to improve the cleanliness of the filtrate.

3. According to the present disclosure, the irradiation modification is carried out in two steps. The first irradiation modification employs lower irradiation intensity and longer irradiation time, while the second irradiation modification employs higher irradiation intensity and shorter irradiation time, which can further improve the uniformity of irradiation-grafted groups. Further, the first irradiation modification makes the filtration membrane have higher crystallinity and better low elution performance, and the filtration membrane is pre-grafted to a certain extent to endow the filtration membrane with certain hydrophilicity. There is no need to use alcohol solvent for wetting again during the second irradiation modification, and the second irradiation modification is mainly used for further improving the degree of grafting of the irradiation-grafted groups and endowing the filtration membrane with better adsorption capacity for metal particles.

### BRIEF DESCRIPTION OF THE DRAWINGS

The present disclosure is further described below with reference to accompanying drawings.

FIG. 1 is a scanning electron microscopy diagram of a first outer surface of an ultra-high molecular weight polyethylene filtration membrane prepared in Embodiment 2, in which the magnification is 20 K×;

FIG. 2 is a scanning electron microscopy diagram of a second outer surface of an ultra-high molecular weight polyethylene filtration membrane prepared in Embodiment 2, in which the magnification is 10 K×;

FIG. 3 is a scanning electron microscopy diagram of a cross section of an ultra-high molecular weight polyethylene filtration membrane prepared in Embodiment 2, in which the magnification is 1 K×;

FIG. 4 is a scanning electron microscopy diagram of a first outer surface of an ultra-high molecular weight polyethylene filtration membrane prepared in Embodiment 3, in which the magnification is 50 K×;

FIG. 5 is a scanning electron microscopy diagram of a second outer surface of an ultra-high molecular weight polyethylene filtration membrane prepared in Embodiment 3, in which the magnification is 50 K×;

FIG. 6 is a diagram of an apparatus for flow rate testing of an ultra-high molecular weight polyethylene filtration membrane according to the present disclosure.

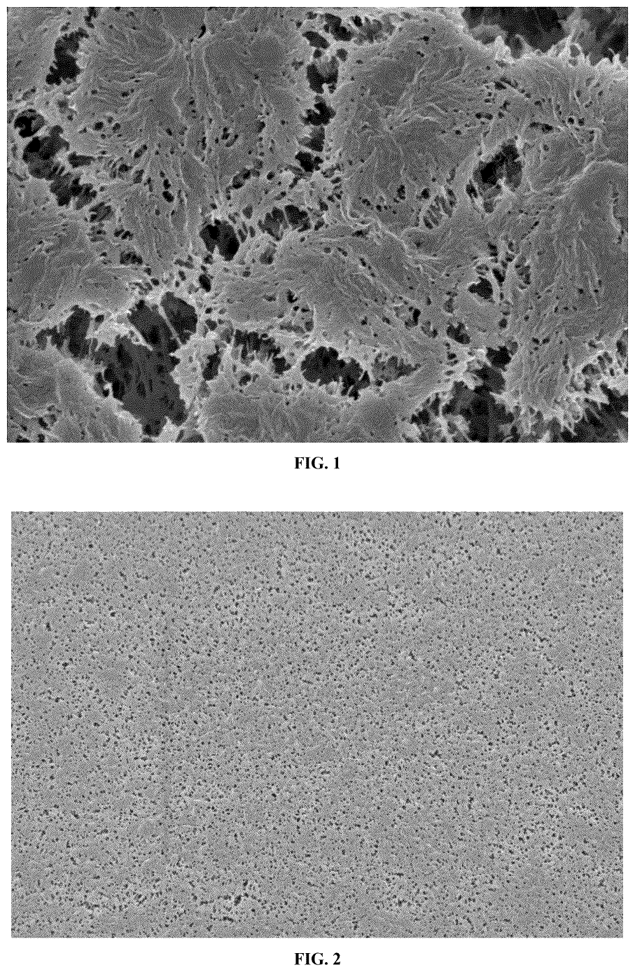

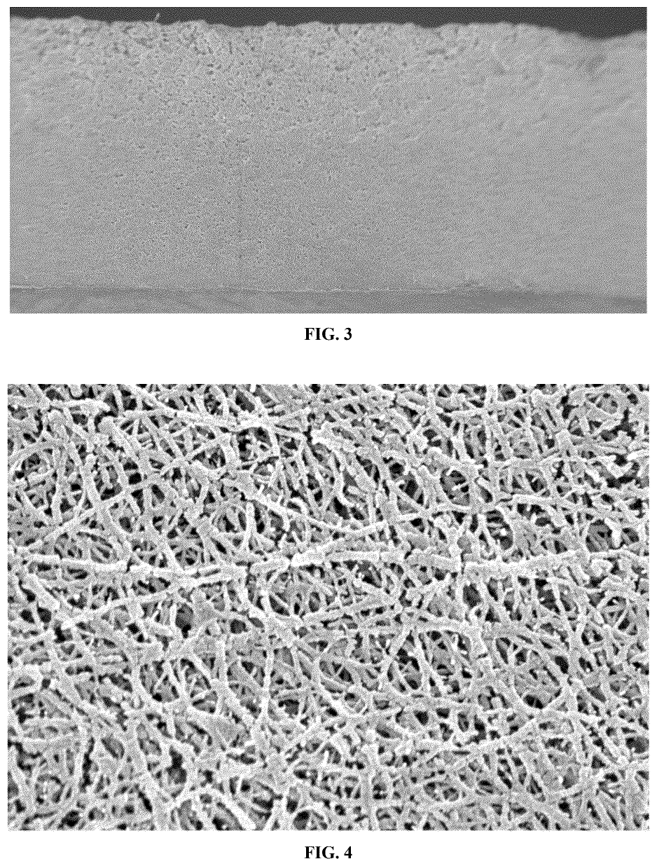

### DETAILED DESCRIPTION OF THE EMBODIMENTS

The present disclosure is further described in detail below in conjunction with embodiments. Unless otherwise specified, in the following embodiments, raw materials and equipment used for preparing a polyolefin filtration membrane can be purchased commercially.

### Embodiment 1

A preparation method for a polyolefin filtration membrane includes the following steps.

S1. A first modification solution is prepared, sulfite and a surfactant are added into water to prepare the first modification solution, where a mass fraction of the sulfite in the first modification solution is 5%, and a mass fraction of the surfactant in the first modification solution is 2.5%.

The sulfite employs sodium sulfite, and the surfactant employs sodium dodecyl sulfate.

S2. The filtration membrane is immersed in a methanol solution with a concentration of 60%, the filtration membrane after infiltration is placed into pure water for immersing and rinsing twice, the filtration membrane is placed in a container filled with the first modification solution, the filtration membrane is completely infiltrated with the first modification solution, and an oxygen environment is introduced.

An UPE filtration membrane is selected as the filtration membrane.

S3. The container filled with the filtration membrane and the first modification solution is irradiated by γ-ray with an irradiation intensity of 0.4 Mrad/h for 20 h, a temperature of feed liquid is controlled at 15° C., a total radiation dose is 8 Mrad, and the filtration membrane is removed from the first modification solution and then immersed in the pure water.

S4. A second modification solution is prepared, the sulfite and a surfactant are added into water to prepare the second modification solution, where the mass fraction of the sulfite in the second modification solution is 10%, and the mass fraction of the surfactant in the second modification solution is 5%.

The sulfite employs sodium sulfite, and the surfactant employs sodium dodecyl sulfate.

S5. The filtration membrane is placed in a container filled with the second modification solution and is completely infiltrated with the second modification solution, and then the container is sealed and then vacuumized for 1 h.

S6. The container filled with the filtration membrane and the second modification solution is irradiated by the γ-ray with an irradiation intensity of 4 Mrad/h for 12.5 h, the temperature of the feed liquid is controlled at 45° C., and the total radiation dose is 50 Mrad; and the filtration membrane is removed from the second modification solution and then immersed in the pure water, and dried to obtain the polyolefin filtration membrane after irradiation modification.

An UPE filtration membrane is selected as the polyolefin filtration membrane.

### Embodiments 2-11

The difference between Embodiments 2-11 and Embodiment 1 is that process parameters are different, as shown in Table 1-1, Table 1-2 and Table 1-3. The sulfite and a surfactant in Embodiments 2 and 4 are different from those in Embodiment 1. In Embodiment 2, the sulfite is potassium sulfite and the surfactant is sodium dodecyl benzene sulfonate; in Embodiment 4, the sulfite is potassium sulfite, and the surfactant is potassium dodecyl sulfate; and crystalline polyolefin used in Embodiment 6 is polypropylene.

### Embodiment 12

The difference between Embodiment 12 and Embodiment 11 is that the filtration membrane is subjected to UV pretreatment, and then is subjected to second irradiation modification by γ-ray, where a modification solution concentration and process parameters in the irradiation modification process are as shown in Table 1-4.

### Embodiment 13

The difference between Embodiment 13 and Embodiment 2 is that the filtration membrane is not subjected to pretreatment, and the filtration membrane is subjected to γ-ray irradiation modification, where a modification solution concentration and process parameters in the irradiation modification process are as shown in Table 1-3.

### Embodiment 14

The difference between Embodiment 14 and Embodiment 2 is that the filtration membrane is not subjected to pretreatment, and the filtration membrane is subjected to UV irradiation modification, where a modification solution concentration and process parameters in the UV irradiation modification process are as shown in Table 1-4.

### Comparative Example 1

The difference between Comparative Example 1 and Embodiment 2 is that γ-ray irradiation modification is carried out only once, and a modification solution concentration and process parameters in the irradiation modification process are as shown in Table 1-3.

### Comparative Example 2

The difference between Embodiment Comparative Example 2 and Embodiment 2 is that UV irradiation modification is carried out only once, and a modification solution concentration and process parameters in the irradiation modification process are as shown in Table 1-4.

TABLE 1-1

| Control condition | | Embodiment 1 | Embodiment 2 | Embodiment 3 | Embodiment 4 | Embodiment 5 |
|---|---|---|---|---|---|---|
| First irradiation | Content of sulfite/% | 5 | 4.5 | 3.5 | 2.5 | 3 |
| modification | Content of | 2.5 | 2.2 | 1.8 | 1 | 1.5 |
| | surfactant/% | | | | | |
| | Temperature of | 15 | 15 | 15 | 15 | 15 |
| | feed liquid/° C. | | | | | |
| | Irradiation | 0.4 | 0.4 | 0.5 | 0.4 | 0.35 |
| | intensity/(Mrad/h) | | | | | |
| | Irradiation time/h | 20 | 20 | 14 | 17 | 19 |
| | Total irradiation | 8 | 8 | 7 | 6.8 | 6.65 |
| | dose/Mrad | | | | | |
| Second irradiation | Content of sulfite/% | 10 | 9.5 | 8 | 7 | 7.5 |
| modification | Content of | 5 | 4.5 | 3.8 | 3 | 3.5 |
| | surfactant/% | | | | | |
| | Temperature of | 45 | 45 | 45 | 45 | 45 |
| | feed liquid/° C. | | | | | |
| | Irradiation | 4 | 4 | 3 | 2.5 | 2.5 |
| | intensity/(Mrad/h) | | | | | |
| | Irradiation time/h | 12.5 | 12 | 14 | 14 | 13 |
| | Total irradiation | 50 | 48 | 42 | 35 | 32.5 |
| | dose/Mrad | | | | | |

TABLE 1-2

| Control condition | | Embodiment 6 | Embodiment 7 | Embodiment 8 | Embodiment 9 | Embodiment 10 |
|---|---|---|---|---|---|---|
| First irradiation | Content of sulfite/% | 3 | 4.5 | 1 | 5 | 2.9 |
| modification | Content of | 1.6 | 2.1 | 0.5 | 2.5 | 1.2 |
| | surfactant/% | | | | | |
| | Temperature of | 15 | 15 | 15 | 20 | 15 |
| | feed liquid/° C. | | | | | |
| | Irradiation | 0.45 | 0.1 | 0.2 | 0.5 | 0.4 |
| | intensity/(Mrad/h) | | | | | |
| | Irradiation time/h | 16.5 | 80 | 20 | 16 | 17 |
| | Total irradiation | 7.425 | 8 | 4 | 8 | 6.8 |
| | dose/Mrad | | | | | |
| Second irradiation | Content of sulfite/% | 7.7 | 8 | 5 | 10 | 7.5 |
| modification | Content of | 3.5 | 3.8 | 2.5 | 5 | 3.1 |
| | surfactant/% | | | | | |
| | Temperature of | 45 | 45 | 35 | 45 | 45 |
| | feed liquid/° C. | | | | | |
| | Irradiation | 3.5 | 1 | 2 | 4 | 3 |
| | intensity/(Mrad/h) | | | | | |
| | Irradiation time/h | 12 | 48 | 12.5 | 12.5 | 11 |
| | Total irradiation | 42 | 48 | 25 | 50 | 33 |
| | dose/Mrad | | | | | |

TABLE 1-3

| | | | | Compar- |
|---|---|---|---|---|
| | | Embodi- | Embodi- | ative |
| Control condition | | ment 11 | ment 13 | Example1 |
| First | Content of sulfite/% | 4 | 9.5 | 0.9 |
| irradiation | Content of surfactant/% | 2.1 | 4.5 | 1.5 |
| modifi- | Temperature of feed | 20 | 45 | 15 |
| cation | liquid/° C. | | | |
| | Irradiation intensity/ | 0.5 | 4 | 0.4 |
| | (Mrad/h) | | | |
| | Irradiation time/h | 15 | 12.5 | 20 |
| | Total irradiation dose/ | 7.5 | 50 | 8 |
| | Mrad | | | |
| Second | Content of sulfite/% | 8.6 | / | / |
| irradiation | Content of surfactant/% | 4 | / | / |
| modifi- | Temperature of feed | 45 | / | / |
| cation | liquid/° C. | | | |
| | Irradiation intensity/ | 4 | / | / |
| | (Mrad/h) | | | |
| | Irradiation time/h | 11 | / | / |
| | Total irradiation dose/ | 44 | / | / |
| | Mrad | | | |

TABLE 1-4

| | | | | Compar- |
|---|---|---|---|---|
| | | Embodi- | Embodi- | ative |
| Control condition | | ment 12 | ment 14 | example 2 |
| First | Content of sulfite/% | 4 | 9.5 | 0.9 |
| irradiation | Content of surfactant/% | 1.8 | 4.5 | 1.5 |
| modifi- | Temperature of feed | 20 | 45 | 15 |
| cation | liquid/° C. | | | |
| | Wavelength/nm | 280 | 280 | 280 |
| | Irradiation time/h | 2 | 2 | 2 |
| | Irradiance/mW/cm² | 1500 | 1500 | 5 |
| Second | Content of sulfite/% | 8.5 | / | / |
| irradiation | Content of surfactant/% | 3.9 | / | / |
| modifi- | Temperature of feed | 45 | / | / |
| cation | liquid/° C. | | | |
| | Irradiation intensity/ | 4 | / | / |
| | (Mrad/h) | | | |
| | Irradiation time/h | 11 | / | / |
| | Total irradiation dose/ | 44 | / | / |
| | Mrad | | | |

### Detection of Membrane Structure Parameters

The morphologies of the polyolefin filtration membranes prepared in Embodiments 1-14 and Comparative Examples 1-2 are characterized using a scanning electron microscope (SEM). The first outer surface, the second outer surface and the cross-section of the polyolefin filtration membrane are selected as observation objects. The specific detection and measurement results are shown in Tables 2-1, 2-2, 2-3, and 2-4. It should be noted that the polyolefin used is the ultra-high molecular weight polyethylene.

When the first cross-sectional fiber and the second cross-section fiber are measured, the first cross-sectional fibers and the second cross-sectional fibers have two morphologies due to the difference of the polyolefin filtration membranes, the first is a polyolefin filtration membrane with lace-like pores on its outer surface, which is formed by the agglomeration of multiple first cross-sectional fibers or second cross-sectional fibers, and characterized by the smallest agglomeration unit when the first cross-sectional fibers and the second cross-sectional fibers are measured. The second is strip fiber, which is characterized by the diameter of the strip when the first cross-sectional fibers and the second cross-sectional fibers are measured.

The oxygen-to-carbon ratio in the filtration membrane is characterized through X-ray photoelectron spectrum (XPS) by irradiating the filtration membrane with X-rays, where the oxygen-to-carbon ratio is calculated by separately analyzing carbon and oxygen spectra to determine relative quantitative proportions of element C in the Cls spectrum and element O in the Ols spectrum, and then the relative quantitative proportions of the element C and the element O are calculated to obtain the overall oxygen-to-carbon ratio of the polyolefin filtration membrane. (It should be noted that a light spot of XPS has a width of approximately 100 μm and a penetration thickness of approximately 10 nm, the relative contents of element C and element O obtained by testing the liquid inlet surface and liquid outlet surface of the filtration membrane are similar, so the relative contents of element C and element O obtained by testing the liquid inlet surface and liquid outlet surface are approximately regarded as the oxygen-to-carbon ratio of the whole filtration membrane)

Original image data obtained by carrying out X-ray diffraction on the filtration membrane is subjected to peak fitting by Jade software to obtain the fitted peaks of the crystalline region and the amorphous region, in which the fitted peaks of the crystalline region are around 2θ=19.6°, 2θ-21.6° and 2θ=23.7°, and the remaining fitted peaks are fitted peaks representing the amorphous region, and then the fitted peak area of each of the crystalline region and the amorphous region is calculated by integration. The crystallinity provided by the present disclosure is equal to an integrated fitted peak area of the crystalline region divided by the sum of the integrated fitted peak area of the crystalline region and the integrated fitted peak area of the amorphous region.

The full width at half maximum refers to a distance between two intersection points of a parallel line with the two sides of the diffraction peak. This is determined by first correcting the diffraction peak on an original XRD pattern, then drawing a tangent line at the base of the corresponding diffraction peak, and finally drawing the parallel line to the tangent at half the peak height.

TABLE 2-1

| Test Parameter | Embodiment 1 | Embodiment 2 | Embodiment 3 | Embodiment 4 | Embodiment 5 |
|---|---|---|---|---|---|
| SEM average pore size of | 548 | 643 | 32.2 | 785 | 824 |
| first outer surface/nm | | | | | |
| SEM average pore size of | 16.2 | 31.2 | 29.8 | 58.7 | 68.6 |
| second outer surface/nm | | | | | |
| Thickness/μm | 95.8 | 57.6 | 28.8 | 62.6 | 60.8 |
| Pore area ratio of first | 13.5 | 17.3 | 19.4 | 21.1 | 23.2 |
| outer surface/% | | | | | |
| Pore area ratio of second | 11.8 | 14.6 | 18.8 | 17.7 | 21.8 |
| outer surface/% | | | | | |
| Pore density of first | 3.2 | 2.6 | 259 | 2.1 | 0.9 |
| outer surface (per μm²) | | | | | |
| Pore density of second | 289 | 264 | 268 | 201 | 194 |
| outer surface (per μm²) | | | | | |
| Porosity/% | 38.3 | 42.1 | 24.3 | 51.3 | 59.7 |
| Average diameter of first | 53.8 | 73.8 | 74.2 | 85.4 | 98.3 |
| cross-sectional fibers/nm | | | | | |
| Average diameter of second | 39.2 | 44.4 | 70.3 | 53.8 | 66.4 |
| cross-sectional fibers/nm | | | | | |
| Weight-Average Molecular | 5 million | 4 million | 3 million | 3 million | 2 million |
| Weight | | | | | |
| Average diameter of fibers | / | / | 84.2 | / | / |
| on first outer surface/nm | | | | | |
| Average diameter of fibers | / | / | 85.6 | / | / |
| on second outer surface/nm | | | | | |
| PMI average pore size/nm | 2 | 5 | 5 | 20 | 50 |
| Oxygen-to-carbon ratio | 0.097 | 0.088 | 0.064 | 0.058 | 0.049 |
| Content of C—O/% | 4.68 | 4.28 | 3.22 | 2.83 | 2.47 |
| Content of C═O content/% | 4.13 | 3.79 | 2.82 | 2.61 | 2.22 |
| Crystallinity/% | 84.5 | 80.1 | 72.3 | 68.7 | 63.2 |
| I_{orthogonal crystal form}:I_{Monoclinic phase} | 60.5 | 50.1 | 50 | 55.3 | 55.1 |
| Full width at half maximum | 1.12 | 1.09 | 0.98 | 0.84 | 0.72 |
| 2θ = around 21.6/° | | | | | |
| Full width at half maximum | 1.08 | 1.13 | 1.01 | 0.89 | 0.71 |
| 2θ around 23.7/° | | | | | |
| First water contact angle | 52.6 | 54.8 | 76.3 | 83.9 | 96.7 |
| of first outer surface/° | | | | | |
| First water contact angle | 50.1 | 52.5 | 76.5 | 82.6 | 94.5 |
| of second outer surface/° | | | | | |

TABLE 2-2

| Test Parameter | Embodiment 6 | Embodiment 7 | Embodiment 8 | Embodiment 9 | Embodiment 10 |
|---|---|---|---|---|---|
| SEM average pore size of | 1024 | 654 | 35.4 | 30.6 | 39.4 |
| first outer surface/nm | | | | | |
| SEM average pore size of | 105.2 | 33.1 | 36.8 | 30.7 | 37.2 |
| second outer surface/nm | | | | | |
| Thickness/μm | 107.4 | 53.7 | 30.4 | 29.7 | 30.9 |
| Pore area ratio of first | 24.8 | 17.8 | 19.8 | 20.1 | 19.2 |
| outer surface/% | | | | | |
| Pore area ratio of second | 24.6 | 14.9 | 18.3 | 19.8 | 19.1 |
| outer surface/% | | | | | |
| Pore density of first | 0.5 | 3 | 238 | 252 | 247 |
| outer surface (per μm²) | | | | | |
| Pore density of second | 135 | 244 | 248 | 250 | 257 |
| outer surface (per μm²) | | | | | |
| Porosity/% | 68.3 | 40.6 | 23.4 | 22.3 | 23.7 |
| Average diameter of first | 110.2 | 67.8 | 76.2 | 77.2 | 75.1 |
| cross-sectional fibers/nm | | | | | |
| Average diameter of second | 78.7 | 39.8 | 76.8 | 75.8 | 76.6 |
| cross-sectional fibers/nm | | | | | |
| Weight-Average Molecular | 3 million | 4 million | 3 million | 3 million | 3 million |
| Weight | | | | | |
| Average diameter of fibers | / | / | 83.2 | 85.2 | 88.2 |
| on first outer surface/nm | | | | | |
| Average diameter of fibers | / | / | 82.1 | 83.1 | 84.1 |
| on second outer surface/nm | | | | | |
| PMI average pore size/nm | 100 | 5 | 5 | 5 | 5 |
| Oxygen-to-carbon ratio | 0.06 | 0.089 | 0.015 | 0.103 | 0.054 |
| Content of C—O/% | 2.98 | 4.07 | 0.9 | 5.02 | 2.58 |
| Content of C═O content/% | 2.75 | 4.09 | 0.6 | 4.34 | 2.51 |
| Crystallinity/% | 71.4 | 76.8 | 35.3 | 94.2 | 66.6 |
| I_{orthogonal crystal form}:I_{Monoclinic phase} | / | 55 | 50 | 50.2 | 30.8 |
| Full width at half maximum | / | 0.68 | 0.69 | 1.23 | 1 |
| 2θ = around 21.6/° | | | | | |
| Full width at half maximum | / | 0.69 | 0.64 | 1.28 | 0.97 |
| 2θ around 23.7/° | | | | | |
| First water contact angle | 81.2 | 54.1 | 98.2 | 51.2 | 90.6 |
| of first outer surface/° | | | | | |
| First water contact angle | 80.8 | 52.6 | 98.8 | 50.8 | 90.8 |
| of second outer surface/° | | | | | |

TABLE 2-3

| | | | | | Comparative |
|---|---|---|---|---|---|
| Test Parameter | Embodiment 11 | Embodiment 12 | Embodiment 13 | Embodiment 14 | Example 1 |
| SEM average pore size of | 654 | 637 | 668 | 633 | 621 |
| first outer surface/nm | | | | | |
| SEM average pore size of | 38.4 | 36.7 | 33.7 | 30.8 | 28.5 |
| second outer surface/nm | | | | | |
| Thickness/μm | 53.8 | 52.4 | 52.1 | 54.8 | 52.4 |
| Pore area ratio of first | 18.6 | 18.1 | 18.8 | 18.4 | 18.5 |
| outer surface/% | | | | | |
| Pore area ratio of second | 14.8 | 14.6 | 15.6 | 14.8 | 15.4 |
| outer surface/% | | | | | |
| Pore density of first | 3 | 2.7 | 2.8 | 3.3 | 3.2 |
| outer surface (per μm²) | | | | | |
| Pore density of second | 246 | 251 | 248 | 248 | 268 |
| outer surface (per μm²) | | | | | |
| Porosity/% | 40.5 | 41.5 | 42.2 | 41.8 | 43.2 |
| Average diameter of first | 70.4 | 74.8 | 75.9 | 70.3 | 67.8 |
| cross-sectional fibers/nm | | | | | |
| Average diameter of second | 150.2 | 13.2 | 48.4 | 38.6 | 45.8 |
| cross-sectional fibers/nm | | | | | |
| Weight-Average Molecular | 4 million | 4 million | 4 million | 4 million | 4 million |
| Weight | | | | | |
| Average diameter of fibers | / | / | / | / | / |
| on first outer surface/nm | | | | | |
| Average diameter of fibers | / | / | / | / | / |
| on second outer surface/nm | | | | | |
| PMI average pore size/nm | 5 | 5 | 5 | 5 | 5 |
| Oxygen-to-carbon ratio | 0.086 | 0.086 | 0.087 | 0.087 | 0.007 |
| Content of C—O/% | 4.19 | 3.75 | 4.21 | 4.18 | 0.4 |
| Content of C═O content/% | 3.69 | 4.21 | 3.80 | 3.82 | 0.3 |
| Crystallinity/% | 78.2 | 78.4 | 72.4 | 72.2 | 32.3 |
| I_{orthogonal crystal form}:I_{Monoclinic phase} | 50.5 | 50.7 | 50.3 | 50 | 50.1 |
| Full width at half maximum | 1.01 | 0.98 | 0.93 | 0.93 | 0.62 |
| 2θ = around 21.6/° | | | | | |
| Full width at half maximum | 1 | 1.02 | 0.98 | 0.95 | 0.58 |
| 2θ around 23.7/° | | | | | |
| First water contact angle | 57.8 | 57.9 | 40.4 | 78.9 | 112.1 |
| of first outer surface/° | | | | | |
| First water contact angle | 55.7 | 55.1 | 40.1 | 76.7 | 112.7 |
| of second outer surface/° | | | | | |

TABLE 2-4

| | Comparative |
|---|---|
| Test Parameter | Example 2 |
| SEM average pore size of first outer surface/nm | 628 |
| SEM average pore size of second outer surface/nm | 30.2 |
| Thickness/μm | 53.8 |
| Pore area ratio of first outer surface/% | 18.4 |
| Pore area ratio of second outer surface/% | 14.2 |
| Pore density of first outer surface (per μm²) | 3.2 |
| Pore density of second outer surface (per μm²) | 254 |
| Porosity/% | 42.7 |
| Average diameter of first cross-sectional fibers/nm | 69.5 |
| Average diameter of second cross-sectional fibers/nm | 45.4 |
| Weight-Average Molecular Weight | 4 million |
| Average diameter of fibers on first outer surface/nm | / |
| Average diameter of fibers on second outer surface/nm | / |
| PMI average pore size/nm | 5 |
| Oxygen-to-carbon ratio | 0.008 |
| Content of C—O/% | 0.42 |
| Content of C═O content/% | 0.33 |
| Crystallinity/% | 31.3 |
| I_{orthogonal crystal form}:I_{Monoclinic phase} | 50.5 |
| Full width at half maximum 2θ = around 21.6/° | 0.63 |
| Full width at half maximum 2θ around 23.7/° | 0.6 |
| First water contact angle of first outer surface/° | 111.5 |
| First water contact angle of second outer surface/° | 111.6 |

### Detection of Membrane Performance Parameters

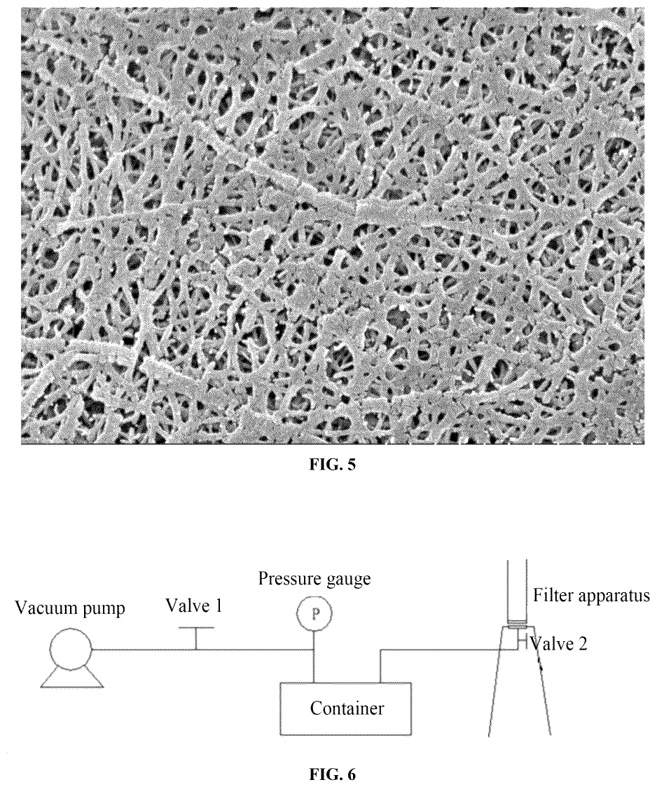

### 1.1. Water Flow Rate Testing (a Test Apparatus is as Shown in FIG. 6)

### Experimental Steps

Step 1: Samples to be tested (polyolefin filtration membranes prepared in Embodiments 1-14 and Comparative Examples 1-2) are wetted by IPA (Isopropyl Alcohol) and then placed on a support for filtration under reduced pressure, a valve 2 on the support for filtration under reduced pressure is closed, a valve 1 is opened, a vacuum pump is turned on, and a pressure is adjusted to a testing pressure of 0.03 MPa, the valve 1 is closed.

Step 2:50 ml of test liquid (water) is filled into a plastic graduated cylinder of the support for filtration under reduced pressure, the valve 2 is opened, timing is started from a certain scale, and the timing is stopped at another scale.

Step 3: After the test is completed, a numerical value displayed by a second chronograph is recorded, and when all test liquid passes through the filtration membrane, the valve 2 on the support is closed, and the samples are taken out.

Detection results are as shown in Table 3.

TABLE 3

| Sample | Flow rate/s |
|---|---|
| Embodiment 1 | 2839 |
| Embodiment 2 | 1268 |
| Embodiment 3 | 1248 |
| Embodiment 4 | 354 |
| Embodiment 5 | 122 |
| Embodiment 6 | 104 |
| Embodiment 7 | 1269 |
| Embodiment 8 | 1243 |
| Embodiment 9 | 1290 |
| Embodiment 10 | 1246 |
| Embodiment 11 | 1268 |
| Embodiment 12 | 1265 |
| Embodiment 13 | 1270 |
| Embodiment 14 | 1266 |
| Comparative Example 1 | 1240 |
| Comparative Example 2 | 1238 |

1.2. Tensile strength testing: the transverse tensile strength and longitudinal tensile strength of each of polyolefin filtration membranes prepared in Embodiments 1-14 and Comparative Examples 1-2 are tested by a universal tensile testing machine, where a width of the tensile machine is 10 mm, a spacing is 30 mm, and the tensile strength MPa is equal to breaking force (cN)/102 divided by a product of an average thickness (mm) and Width (mm) (1N=102 cN, and 1 mm=1000 μm), where the longitudinal tensile strength is a tensile strength along a winding direction of the membrane, and the transverse tensile strength is a tensile strength in a direction perpendicular to the winding direction of the membrane, with testing results shown in Table 4.

TABLE 4

| | Transverse tensile | Longitudinal tensile |
|---|---|---|
| Sample | strength/MPa | strength/MPa |
| Embodiment 1 | 14.56 | 17.24 |
| Embodiment 2 | 14.13 | 16.98 |
| Embodiment 3 | 10.11 | 13.01 |
| Embodiment 4 | 12.48 | 15.34 |
| Embodiment 5 | 12.02 | 15.08 |
| Embodiment 6 | 13.14 | 15.98 |
| Embodiment 7 | 10.23 | 13.18 |
| Embodiment 8 | 8.23 | 10.88 |
| Embodiment 9 | 9.01 | 11.23 |
| Embodiment 10 | 9.78 | 12.39 |
| Embodiment 11 | 14.02 | 16.75 |
| Embodiment 12 | 12.02 | 15.21 |
| Embodiment 13 | 13.28 | 16.18 |
| Embodiment 14 | 13.21 | 16.01 |
| Comparative Example 1 | 6.88 | 8.64 |
| Comparative Example 2 | 6.81 | 8.69 |

### 1.3. TOC Elution Amount Testing

The polyolefin filtration membranes prepared in Embodiments 1-14 and Comparative Examples 1-2 are made into filter elements with an effective filtration area of 0.55 m². A filter containing the filter element is sterilized by high-pressure steam at 130° C. for 30 min, and the filter is connected to an ultra-pure water source with TOC meeting the requirements of water for injection for flushing, with a flushing volume controlled at 20 L and a flushing speed controlled at 500 ml/min. The downstream filtrate is tested for TOC testing (testing instrument: TOC analyzer), with testing results shown in Table 5.

TABLE 5

| Sample | TOC dissolution amount/ppb |
|---|---|
| Embodiment 1 | 0.278 |
| Embodiment 2 | 0.315 |
| Embodiment 3 | 0.332 |
| Embodiment 4 | 0.339 |
| Embodiment 5 | 0.345 |
| Embodiment 6 | 0.333 |
| Embodiment 7 | 0.351 |
| Embodiment 8 | 0.481 |
| Embodiment 9 | 0.218 |
| Embodiment 10 | 0.342 |
| Embodiment 11 | 0.322 |
| Embodiment 12 | 0.321 |
| Embodiment 13 | 0.333 |
| Embodiment 14 | 0.334 |
| Comparative Example 1 | 0.525 |
| Comparative Example 2 | 0.529 |

### 1.4. Interception Efficiency for Metal Particles

The polyolefin filtration membranes prepared in Embodiments 1-14 and Comparative Examples 1-2 are tested for the interception efficiency for metal particles.

### Experimental Steps are as Follows.

A sample solution is prepared, an appropriate amount of Au particles is added into a propylene glycol methyl ether acetate solution, where the sample solution is divided into four sample groups based on different particle sizes of Au particles, numbered as 1 to 4. The particle sizes of Au particles in the sample groups 1-4 are 2-5 nm, 15-20 nm, 40-50 nm and 90-100 nm, respectively, and the sample solutions 1-4 are tested by ICP-MS (Inductively Coupled Plasma Mass Spectrometer) to obtain initial Au particle concentrations in the sample solutions 1-4, where the initial Au particle concentrations in the sample solutions 1-4 are all controlled about 1-3 ppb. The sample solutions 1-4 are enabled to correspondingly pass through filtration membranes with the PMI average pore sizes of 5 nm, 20 nm, 50 nm and 100 nm, respectively, and filtrates obtained by filtration are tested by using the ICP-MS to acquire Au particle concentrations in the filtrates. (It should be noted that the filtration membrane with a PMI average pore size of 2 nm in the present is tested using the sample solution 1)

Interception efficiency for Au particles is as follows:

$$η = ( 1 - \frac{{n}_{1}}{{n}_{0}} ) \times 100 \% ;$$

where in the formula: η represents interception efficiency (%), n₀ represents an Au particle concentration in the sample solution (an average of 5 counts), and n₁ represents an Au particle concentration in the filtrate (average of 5 counts). (It should be noted that the interception efficiency for the metal particles is characterized by Au particles).

The testing results of the interception efficiency for the metal particles in Embodiments 1-14 and Comparative Examples 1-2 are shown in Table 6, in which the interception efficiency test is also carried out for an original membrane without any modification treatment in Embodiment 2.

TABLE 6

| Sample | Interception efficiency/% |
|---|---|
| Embodiment 1 | 99.24 |
| Embodiment 2 | 98.65 |
| Embodiment 3 | 97.58 |
| Embodiment 4 | 96.62 |
| Embodiment 5 | 95.18 |
| Embodiment 6 | 97.22 |
| Embodiment 7 | 97.77 |
| Embodiment 8 | 93.58 |
| Embodiment 9 | 99.36 |
| Embodiment 10 | 96.38 |
| Embodiment 11 | 98.32 |
| Embodiment 12 | 98.36 |
| Embodiment 13 | 98.52 |
| Embodiment 14 | 98.58 |
| Comparative Example 1 | 42.35 |
| Comparative Example 2 | 41.02 |
| Original membrane in Embodiment 2 | 12.31 |

From Tables 2-1, 2-2 and 2-3 and in combination with Tables 4 to 6, it can be learned that the filtration membrane provided by the present disclosure has a wide PMI average pore size distribution, which can meet the filtration requirements for different filtration particles, and the filtration membrane has good longitudinal and transverse tensile strength, as well as excellent low elution performance, so that the filtered filtrate has high cleanliness to meet the requirements of high cleanliness in the semiconductor field, solvent filtration, photoresist filtration, and the like. In addition, the filtration membrane provided by the present disclosure has high interception efficiency for metal particles, which can effectively remove metal particles from the organic solvents and can also effectively remove microgel particles in photoresist filtration.

From Tables 2-1 and 2-2 and in combination with Tables 4 to 6, it can be seen that when a ratio of the content of “C—O” to the content of “C═O” in Embodiment 7 is relatively low, the change of the overall oxygen-to-carbon ratio of the filtration membrane is not obvious, but it may lead to a certain degree of decrease in the crystallinity of the filtration membrane and the interception efficiency for the metal particles. The possible reason is that at the low irradiation intensity of 0.2-0.5 Mrad/h, the energy generated by γ-ray irradiation for modification grafting is relatively less. In this case, as the bond energy of “C—O” is lower than that of “C—O”, a ratio of the content of “C—O” to the content of “C—O” is reduced. In addition, as the electronegativity of “C—O” is greater than that of “C═O”, the adsorption capacity endowed to the polyolefin membrane for the metal particles by the “C—O” and “C═O” is reduced.

From Tables 2-2 and 2-3, Table 5 and Table 6 and in combination with Embodiment 3, it can be learned that when the crystallinity of the filtration membrane of the present disclosure does not fall within the range of 45-85% defined in the dependent claims, as in Embodiment 8 (the crystallinity is lower than 45%), although the flow rate performance of the filtration membrane is improved to some extent, the adsorption efficiency of the filtration membrane for metal particles is reduced to some extent, and the longitudinal tensile strength, transverse tensile strength and low elution performance of the filtration membrane show a relatively significant decrease. As in Embodiment 9 (the crystallinity is higher than 85%), although the adsorption efficiency of the filtration membrane for metal particles and the low elution performance have been improved to some extent, and the longitudinal tensile strength and transverse tensile strength of the filtration membrane have been significantly enhanced, but the flow rate of the filtration membrane decreases to some extent, which in turn affects the application of the filtration membrane in high flow rate requirements. The possible reason is that when the crystallinity is too high, the low elution performance of the filtration membrane is better, but the higher the crystallinity of the filtration membrane, and the higher the oxygen-to-carbon ratio of the filtration membrane. The higher the oxygen-to-carbon ratio, the more the quantity of the oxygen-containing functional groups acting on the surface of the pores, which has a greater impact on the flow rate, making the filtration membrane unable to meet the high-flow-rate filtration application.

From Tables 2-1 and 2-2 and in combination with Embodiments 5 and 10, it can be learned that when the proportions of the orthorhombic crystal form and the monoclinic phase are lower than a lower limit defined in the dependent claims, the low elution performance of the filtration membrane decreases to some extent. The possible reason is that the higher the proportion of orthorhombic crystal form, the better thermal stability of the filtration membrane and the better the grafting stability of the irradiation-grafted groups, thereby reducing the probability of elution of the irradiation-grafted groups. In addition, the better the grafting stability of irradiation-grafted groups, the better the sustained adsorption capacity of the irradiation-grafted groups for metal particles, thereby improving the interception efficiency for the metal particles.

From Table 2-1, Table 2-3 and Table 6 and in combination with Embodiment 4 and Embodiments 11-12, it can be seen that the low elution performance of the filtration membrane decreases to a certain extent when the diameter of the first cross-sectional fibers and the second cross-sectional fibers is too thin, and the low elution performance of the filtration membrane increases to a certain extent when the diameter of the first cross-sectional fibers and the second cross-sectional fibers is too thick. The possible reason is that when the first and second cross-sectional fibers are too thin, their specific surface areas are larger and their adsorption performance is better, but the first and second cross-sectional fibers are more prone to elution, while when the first and second cross-sectional fibers are too thick, their specific surface areas are smaller, but their low elution performance is relatively good.

From Table 2-1, Table 2-3, Table 2-4 and Table 6 and in combination with Embodiment 2, Embodiment 13, Embodiment 14 and Comparative Examples 1-2, it can be seen that the method of twice irradiation modification in the present disclosure makes the filtration membrane have excellent crystallinity and better low elution performance, and also endows the filtration membrane with high interception efficiency for the metal particles. During γ-ray irradiation, when the total irradiation dose is low, the crystallinity, longitudinal tensile strength and transverse tensile strength of the filtration membrane decrease significantly, and the adsorption efficiency of the filtration membrane for the metal particles is obviously affected and decreases. Secondly, the flow rate of the filtration membrane increases to some extent due to the decrease of the oxygen-to-carbon ratio. When the total radiation dose is high, the crystallinity, longitudinal tensile strength and transverse tensile strength of the filtration membrane increase to some extent, but the flow rate of the filtration membrane decreases to some extent.

The preferred embodiments of the present disclosure have been described in detail above. However, it should be understood that after reading the foregoing teachings of the present disclosure, those skilled in the art can make various changes or modifications to the present disclosure. These equivalent forms also fall within the scope of the present disclosure as defined by the appended claims.

What is claimed is:

1. A polyolefin filtration membrane, comprising a main body, wherein both sides of the main body are provided with a first outer surface and a second outer surface, respectively, a non-directional tortuous pathway is formed in the main body, and a space between the first outer surface and the second outer surface is composed of continuous fibers;
a PMI (Porous Materials Inc) average pore size of the filtration membrane is 2-100 nm, and
the filtration membrane has an oxygen-to-carbon ratio in the range from 0.01 to 0.10.

2. The polyolefin filtration membrane according to claim 1, wherein an XPS (X-ray Photoelectron Spectroscopy) analysis spectrum of the filtration membrane comprises “C—O” and “C—O”, wherein a content of “C—O” is 0.6-5%, a content of “C═O” is 0.5-4.5%, and a ratio of the content of “C—O” to “C—O” is 0.5-2.

3. The polyolefin filtration membrane according to claim 1, wherein the polyolefin is crystalline polyolefin, and crystallinity of the filtration membrane is 45-85% measured by an XRD method.

4. The polyolefin filtration membrane according to claim 3, wherein the filtration membrane satisfies that a ratio of I_{orthogonal crystal form} to I_{monoclinic phase} is greater than or equal to 50;
I_{orthogonal crystal form} is a scattering intensity of an UPE (Ultra-high Molecular Weight Polyethylene) filtration membrane at 2θ angles around 21.6° and 23.7°; and
I_{monoclinic phase} is a scattering intensity of the UPE filtration membrane at a 2θ angle around 19.6°.

5. The polyolefin filtration membrane according to claim 4, wherein a full width at half maximum of a characteristic peak of the filtration membrane at the 2θ angle around 21.6° is 0.4°-1.5°; and a full width at half maximum of a characteristic peak of the filtration membrane at the 2θ angle around 23.7° is 0.4°-1.5°.

6. The polyolefin filtration membrane according to claim 3, wherein an SEM (Scanning Electron Microscopy) average pore size of the first outer surface is not less than that of the second outer surface, the SEM average pore size of the second outer surface is 15-100 nm, and a thickness of the filtration membrane is 20-12θ μm.

7. The polyolefin filtration membrane according to claim 3, wherein a pore area ratio of the second outer surface is 10-30%, and a pore density of the second outer surface is 120-300 per μm².

8. The polyolefin filtration membrane according to claim 3, wherein an overall porosity of the filtration membrane is 20-70%, the filtration membrane is provided with second cross-sectional fibers close to the second outer surface in a thickness direction, and an SEM average diameter of the second cross-sectional fiber is 30-100 nm.

9. The polyolefin filtration membrane according to claim 8, wherein the filtration membrane has a weight-average molecular weight from 2 million to 5 million, and a first water contact angle of the second outer surface is 40°-120°.

10. The polyolefin filtration membrane according to claim 8, wherein the filtration membrane is provided with first cross-sectional fibers close to the first outer surface along the thickness direction, an SEM average diameter of the first cross-sectional fiber is 30-110 nm, and a first water contact angle of the first outer surface is 40°-120°.

11. The polyolefin filtration membrane according to claim 6, wherein the SEM average pore size of the first outer surface is greater than that of the second outer surface, and the SEM average pore sizes from the first outer surface to the second outer surface gradually change in a gradient manner, the SEM average pore size of the first outer surface is 500-2000 nm, and the SEM average pore size of the second outer surface is 15-100 nm.

12. The polyolefin filtration membrane according to claim 11, wherein a pore density of the first outer surface is 0.5-80 per μm², and a pore area ratio of the first outer surface is 10-25%.

13. The polyolefin filtration membrane according to claim 6, wherein the SEM average pore sizes from the first outer surface to the second outer surface are arranged symmetrically, and the SEM average pore sizes of the first outer surface and the second outer surface are 15-100 nm.

14. The polyolefin filtration membrane according to claim 13, wherein the pore density of the first outer surface is 150-300 per μm², and the pore area ratio of the first outer surface is 10-30%.

15. The polyolefin filtration membrane according to claim 13, wherein an average diameter of the fibers on the first outer surface is 50-150 nm, and an average diameter of the fibers on the second outer surface is 50-100 nm.

16. The polyolefin filtration membrane according to claim 1, wherein the filtration membrane has a longitudinal tensile strength of 6-18 MPa, and a transverse tensile strength of 4-16 MPa;
an evolution amount of TOC (Total Organic Carbon) from the filtration membrane does not exceed 0.5 ppb; and
under a positive pressure of 0.03 MPa and a temperature of 20° C., time required for 50 ml of water to pass through a porous filtration membrane with a diameter of 47 mm is 100-3000 s.

17. The polyolefin filtration membrane according to claim 1, wherein the polyolefin is any one of PE (Polyethylene), PP (Polyethylene) and UPE.

18. A preparation process for the polyolefin filtration membrane according to claim 1, comprising the following process steps:
S1, preparing a modification solution, wherein sulfite with a mass fraction of 2.5-10% and a surfactant with a mass fraction of 1-5% are added into water to prepare the modification solution;
S2, immersing a filtration membrane in an alcohol solution, placing the infiltrated filtration membrane into pure water for immersing and rinsing, and immersing the filtration membrane in the modification solution for feed-liquid replacement; and
S3, irradiating the filtration membrane immersed with the modification solution by rays, controlling ray irradiation to control an oxygen-to-carbon ratio of the filtration membrane within 0.01-0.1, removing the filtration membrane from the modification solution, immersing the filtration membrane in the pure water, and drying the filtration membrane to obtain a polyolefin filtration membrane.

19. The preparation process for the polyolefin filtration membrane according to claim 18, wherein in step S3, the filtration membrane immersed with the modification solution is subject to UV (Ultraviolet) irradiation, a temperature of feed liquid is controlled at 30-50° C., an irradiance is controlled at 10-200 mW/cm², a wavelength of the UV irradiation is 100-32θ nm, and the irradiation lasts for 10-30 min.

20. The preparation process for the polyolefin filtration membrane according to claim 18, wherein in step S3, the filtration membrane is immersed in a container filled with the modification solution, and the container is sealed and then vacuumized for 1-3 h; the container filled with the modification solution and the filtration membrane is subjected to γ-ray irradiation with an irradiation intensity of 2-4 Mrad/h for 13-25 h, the temperature of the feed liquid is controlled at 30-50° C., and a total radiation dose is 25-50 Mrad; and the filtration membrane is immersed in the pure water after being removed from the solution, and then dried to obtain the polyolefin filtration membrane.

21. The preparation process for the polyolefin filtration membrane according to claim 20, wherein the filtration membrane is further subjected to pretreatment,
the pretreatment comprises γ-ray pretreatment:
(1) preparing a pre-modification solution, wherein sulfite with a mass fraction of 1-5% and a surfactant with a mass fraction of 0.5-2.5% are added into water to prepare the pre-modification solution, the mass fractions of the sulfite and a surfactant in the pre-modification solution are lower than those of the sulfite and the surfactant in the modification solution;
(2) immersing the filtration membrane in an alcohol solution, placing the infiltrated filtration membrane in the pure water for immersing and rinsing, and immersing the filtration membrane in a container filled with the pre-modification solution for feed-liquid replacement, and introducing an oxygen environment; and
(3) irradiating the container filled with the pre-modification solution and the filtration membrane by γ-rays with an irradiation intensity of 0.2-0.5 Mrad/h for 16-40 h, wherein irradiation time in the pre-modification process is longer than that in the modification process, the temperature of the feed liquid is controlled at 10-25° C., and the total radiation dose is 4-8 Mrad; and removing the filtration membrane from the pre-modification solution, and immersing the filtration membrane in the pure water; or
the pretreatment comprises UV pretreatment:
(1) preparing a pre-modification solution, wherein sulfite with a mass fraction of 1-5% and a surfactant with a mass fraction of 0.5-2.5% are added into water to prepare the pre-modification solution, and the mass fractions of the sulfite and a surfactant in the pre-modification solution are lower than those of the sulfite and the surfactant in the modification solution;
(2) immersing the filtration membrane in an alcohol solution, placing the infiltrated filtration membrane in the pure water for immersing and rinsing, and immersing the filtration membrane in a container filled with the pre-modification solution for feed-liquid replacement; and
(3) irradiating the container filled with the pre-modification solution and the filtration membrane by UV irradiation, controlling a temperature of the feed liquid at 10-25° C., and controlling an irradiance at 1000-2000 mW/cm², wherein a wavelength of the UV irradiation is 100-32θ nm, and the irradiation lasts for 1-3 h; and removing the filtration membrane from the pre-modification solution, and then immersing the filtration membrane in the pure water.

22. The preparation process for the polyolefin filtration membrane according to claim 18,
wherein the sulfite is sodium sulfite and potassium sulfite, and the surfactant is sodium dodecyl sulfate and sodium dodecyl benzene sulfonate.
